(19) United States
(12) Patent Application Publication
(10) Pub. No.: US 2013/0275856 A1
(43) Pub. Date: Oct. 17, 2013

(54) METHOD, SYSTEM, AND APPARATUS FOR PROVIDING DATA REGARDING THE OPERATION AND MONITORING OF A CONTROL SYSTEM

(71) Applicant: Spectrum Controls, Inc., (US)

(72) Inventors: Deborah A. Louis Wallace, Kirkland, WA (US); Cynthia A. Louis Wallace, Kirkland, WA (US)

(73) Assignee: SPECTRUM CONTROLS, INC., Bellevue, WA (US)

(21) Appl. No.: 13/668,084

(22) Filed: Nov. 2, 2012

Related U.S. Application Data
(63) Continuation of application No. 09/842,366, filed on Apr. 24, 2001, now abandoned.
(60) Provisional application No. 60/199,207, filed on Apr. 24, 2000.

(51) Int. Cl. G06F 17/22

(52) U.S. Cl. CPC G06F 17/2247
USPC 715/234

(57) ABSTRACT

A system and method are provided for providing data regarding the operation of a control system. A Web server module is provided that is electrically connected to a control system controller. The Web server module contains a memory operative to store a non-markup language Web site database that completely defines a Web site for providing information regarding control system. A Web server module configuration application is also provided that receives user input to create the Web site database. The Web site database is transmitted to the Web server module from the Web site configuration application. When a request is received at the Web server module for a Web page, the Web server module utilizes the Web site database to dynamically generate the requested Web page.

### CROSS-REFERENCE TO RELATED APPLICATIONS

This application is a continuation of U.S. Provisional patent application Ser. No. 09/842,366, filed Apr. 24, 2001, which claims the benefit of U.S. Provisional Patent Application No. 60/199,207, filed Apr. 24, 2000. These applications are expressly incorporated herein by reference.

### FIELD OF THE INVENTION

The present invention generally relates to the field of process control systems. More specifically, the present invention relates to a method, system, and apparatus for providing an interface to data available within a process control system, such as a programmable logic controller.

### BACKGROUND OF THE INVENTION

A programmable logic controller (“PLC”) is an electronic device utilized to perform industrial process and machine control. In general, a PLC works by examining a number of inputs and, depending upon the state of the inputs, adjusting the state of one or more outputs. A user enters a program, usually via “ladder” logic or some other programming means, that provides the desired results. Because of the high degree of reliability associated with PLC operation, PLCs are utilized in countless real-world applications, such as machining, packaging, assembly, material handling, and others.

A PLC typically consists of a central processing unit (“CPU”), memory areas, and appropriate circuitry for receiving input and providing output. The memory areas typically contain information regarding the status of the industrial process that the PLC is controlling. For instance, a memory area contain data regarding the number of cans of tomatoes that have passed a certain point on a conveyor belt during the previous 30 seconds. Because access to this type of information is very important to the operator of a PLC, several types of devices have been developed to gain access to it.

One type of device for accessing data contained in the memory of a PLC is the traditional operator interface (“OI”). A traditional OI is a hardware unit that includes a display and a key panel that is intended for plant floor use. An OI connects directly to a PLC and be programmed, through the use of custom configuration software, to display data screens regarding the PLC operation. The OI also permit a user to control aspects of the operation of the PLC. In general, once programmed, an OI is the primary interface to the PLC for the user. However, the OI does have some limitations. In particular, while an OI is exceptionally useful for controlling and accessing a PLC in an area that is physically close to the PLC, an OI cannot provide remote access to PLC data. Moreover, because custom configuration software must be utilized to program the display and control functions of the OI, it can be expensive and time consuming to reprogram the OI to display different data screens.

Another type of device for accessing data contained in the memory of a PLC is a larger solution system, a human machine interface (“HMI”) or man machine interface (“MMI”). An HMI or MMI package is a software package that can be configured and run on a personal computer (“PC”) set up for that purpose. It can then remotely access the required PLCs to gather and control PLC system data. This solution has limitations as well. This software solution is a larger scale implementation requiring expensive PC hardware and additional interface equipment. The HMI and MMI packages generally support higher level and more complex control and visualization functionality. The packages are generally sold by a license per seat, and are a higher end, and more expensive, solution than local OI.

Another type of device for accessing data contained in the memory of a PLC is a World Wide Web (“Web”) server. In a typical implementation, a hardware Web server module is created that comprises a physically small but conventional server computer. The Web server module connects to the PLC via a backplane bus interface or another type of interface. The Web server module usually has an Ethernet or other type of interface that allows that Web server module to reside on the Internet. The Web server can receive and respond to requests for Web pages containing data regarding the operation of the PLC. In this manner, data regarding the operation of the PLC can be provided to any computer that is equipped with a Web browser.

Web server modules utilized to provide data regarding the operation of a PLC are also not without their drawbacks. The biggest drawback of such Web server modules is the difficulty in creating and modifying the Web site that is provided by the Web server module, as well as associating the PLC data with table entries or non-text renderings within the markup language format. This process is typically an arduous one that involves an operator creating each of the Web pages of the Web site using a standard markup language, such as the hyper-text markup language (“HTML”) or the extensible markup language (“XML”), and possibly a programming language such as JAVA® from Sun Microsystems. While PLC operators are typically well versed in ladder logic, HTML, XML, and JAVA are typically foreign topics. Therefore, creation of the Web pages to be served by the Web server module be a time consuming and expensive process.

Once the Web pages to be served by the Web server module have been created, they are typically transferred to the Web server module. The Web server module uses non-volatile memory to store the Web pages and any associated information, like graphics. Typically, a standard file system is created within the non-volatile memory, with all the HTML contents for a page rendering stored there. In this manner, the Web server module can access the Web pages in a traditional fashion as requests are received. Because of the small physical size requirements for a rack-mounted Web server module and the high price of non-volatile memory, the amount of memory in the Web server module be severely limited. This limited memory directly limits the number of Web pages and the complexity of the Web pages that be stored within, and served by, the Web server module.

Therefore, in light of the above, there is a need for a method, system, and apparatus for providing data regarding the operation of a control system that does not require a user to create a Web site using a markup language. There is a further need for a method, system, and apparatus for providing data regarding the operation of a control system that stores data defining the Web site in a manner that requires less memory than storing conventional markup language Web pages.

### SUMMARY OF THE INVENTION

The present invention satisfies the needs described above by providing a method and system for providing data regarding the operation of a control system, such as a PLC, that does not require a user to create a Web site using a markup language. Moreover, the present invention meets the above needs by providing a method and system for providing data regarding the operation of a control system that stores data defining the Web site in a manner that requires less memory space than storing conventional markup language Web pages. The present invention also provides a method and system for providing data regarding the operation of a control system that includes additional advantages not found in the prior art.

Generally described, the present invention provides a Web server module that is associated with a control system. According to one actual embodiment of the present invention, the Web server module be electrically connected to a backplane of a PLC and receive power and signal information directly from the PLC over the backplane. The Web server module also be connected to the PLC or other type of control system through a serial port, or other network interface port. The Web server also be integrated within a PLC or system controller. The Web server module contains a memory operative to store a non markup language Web site database that completely defines the Web site. Because the Web site database is not stored as markup language documents, it is typically much smaller in size than a similar Web site stored as markup language documents.

The present invention also comprises a computer system operative to receive non-markup language configuration data from a user defining the Web site. This information is stored as a Web site database and is transmitted to the Web server module from the computer system. The Web server module can then utilize the Web site database to dynamically generate a markup language Web page when requests are received.

More specifically described, the present invention comprises a Web server module and a Web server module configuration application. The Web server module is associated with a PLC and is operative to receive data regarding the operation of the control system. The Web server module be connected to the PLC or other type of control system via a backplane interface, a serial port interface, or other type of interface. The Web server module stores a Web site database that completely defines a Web site in a non-markup language format. The Web server module configuration application receives user input to create the Web site database. The Web site database is then transmitted to the Web server module. When a request is received at the Web server module for a Web page, the Web server module utilizes the Web site database to dynamically generate the requested Web page.

The Web site database includes a security profile map that defines a security level and other privilege information for one or more users. When a request is received at the Web server module, the Web server module identifies a user associated with the request and determines if the user is authorized to receive the Web page based upon privileges in the security profile map associated with the user. If the user is authorized to receive the Web page, the Web server module dynamically generates the Web page data and transmits it to the user in response to the request.

The present invention also comprises an apparatus, system, and computer-readable medium for providing data regarding the operation of a control system.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B are block diagrams showing several illustrative operating environments for actual embodiments of the present invention.

FIG. 2 is a block diagram showing an illustrative computer architecture for a client computer utilized in an actual embodiment of the present invention.

FIG. 3 is a block diagram showing an illustrative computer architecture for a programmable logic controller utilized in an actual embodiment of the present invention.

FIG. 4 is a block diagram showing an illustrative computer architecture for a Web server module provided in an actual embodiment of the present invention.

FIG. 5 is a block diagram showing a flash memory map for a Web server module provided in an actual embodiment of the present invention.

FIG. 6 is a block diagram showing a data structure for a form map utilized in an actual embodiment of the present invention.

FIG. 7 is a block diagram showing a data structure for a screen map database utilized in an actual embodiment of the present invention.

FIG. 8 is a block diagram showing a data structure for a table definition map utilized in an actual embodiment of the present invention.

FIG. 9 is a block diagram showing a data structure for a tag database utilized in an actual embodiment of the present invention.

FIG. 10 is a block diagram showing a data structure for a register to tag map utilized in an actual embodiment of the present invention.

FIG. 11 is a block diagram showing a data structure for a graphics database utilized in an actual embodiment of the present invention.

FIG. 12 is a block diagram showing a screen map for a predefined Web site utilized in an actual embodiment of the present invention.

FIG. 13 is a state diagram illustrating the top level operation of a Web server module provided in an actual embodiment of the present invention.

FIG. 14 is a state diagram illustrating hyper-text transport protocol processing in a Web server module provided in an actual embodiment of the present invention.

FIG. 15 is a state diagram illustrating the preprocessing of Web data requests in a Web server module provided in an actual embodiment of the present invention.

FIG. 16 is a state diagram illustrating a process for identifying appropriate processing for a particular Web data request in a Web server module provided in an actual embodiment of the present invention.

FIG. 17 is a state diagram illustrating a process for issuing screen data in a Web server module provided in an actual embodiment of the present invention.

FIG. 18 is a state diagram illustrating a process for rendering table data in a Web server module provided in an actual embodiment of the present invention.

FIG. 19 is a state diagram illustrating a process for rendering fixed table data in a Web server module provided in an actual embodiment of the present invention.

FIG. 20 is a state diagram illustrating a process for rendering variable table data in a Web server module provided in an actual embodiment of the present invention.

FIG. 21 is a state diagram illustrating a process for rendering queued table data in a Web server module provided in an actual embodiment of the present invention.

FIG. 22 is a state diagram illustrating a process for rendering a data table header in a Web server module provided in an actual embodiment of the present invention.

FIG. 23 is a state diagram illustrating a process for posting form data in a Web server module provided in an actual embodiment of the present invention.

FIG. 24 is a state diagram illustrating a method for implementing security profile support utilized in an actual embodiment of the present invention.

FIG. 25 is a state diagram illustrating a backplane hardware and software interface utilized in an actual embodiment of the present invention.

FIG. 26 is a state diagram illustrating a task for reading backplane data utilized in an actual embodiment of the present invention.

FIG. 27 is a state diagram illustrating a task for writing backplane data utilized in an actual embodiment of the present invention.

FIGS. 28-34 are screen diagrams showing various aspects of a Web server module configuration application utilized in an actual embodiment of the present invention.

### DETAILED DESCRIPTION OF AN ILLUSTRATIVE EMBODIMENT

As described briefly above, the present invention provides a method, system, and apparatus for providing data regarding the operation of a control system. According to one actual embodiment of the invention, a system is provided that comprises a Web server module associated with a PLC. The Web server module connect to the PLC through one of several different interfaces to obtain data regarding the operation of the PLC. The Web server module also comprise an interface upon which requests are received for a Web site that provides data regarding the operation of the PLC.

The Web site provided by the Web server module is defined utilizing a remote computer system and a Web server module configuration application. The Web server module configuration application provides an easy-to-use interface for defining the Web site provided by the Web server module. The Web server module configuration application does not require a user to define the Web site using markup language. Rather, the Web server module configuration application allows a user to define the Web site using easy-to-use menus and interfaces.

Once the Web site has been defined, a Web site database is transmitted to the Web server module. The Web server module utilize the Web site database to dynamically generate markup language pages when requests are received. Because the Web site database is not stored as markup language files, the Web site database takes up considerably less memory space than conventional files stored in file systems on conventional Web servers. Additional aspects regarding several illustrative embodiments of the present invention will be apparent from the following

### DETAILED DESCRIPTION

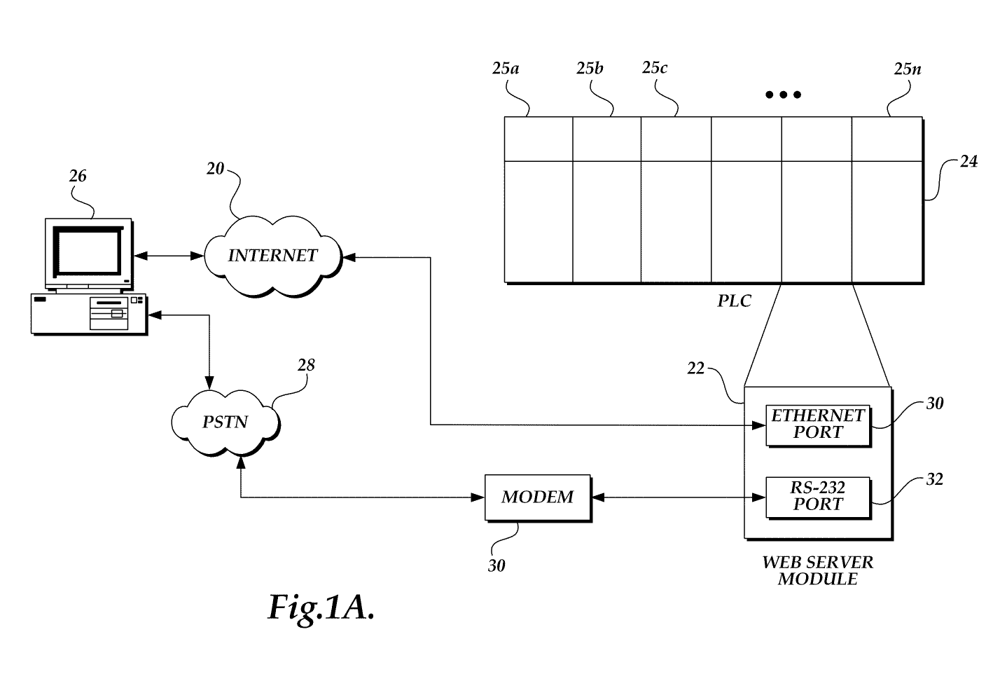

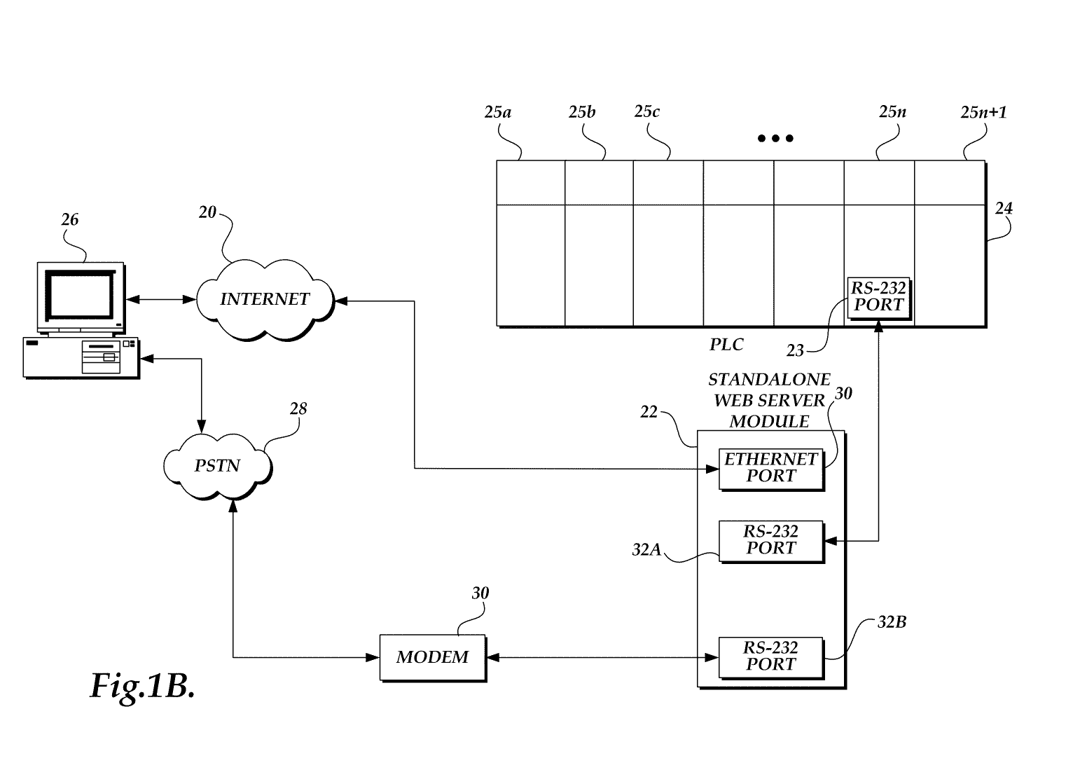

Turning now to the figures, in which like numerals represent like elements, several actual embodiments of the present invention will be described. Referring now to FIG. 1A, an illustrative operating environment for an actual embodiment of the present invention will be described. As shown in FIG. 1A, a PLC 24 comprises an operating environment for an actual embodiment of the present invention. The PLC 24 utilized in the actual embodiment of the present invention described herein is the family of programmable controllers available from ALLEN-BRADLEY/ROCKWELL AUTOMATION under the trademark SLC500. As known to those skilled in the art, the SLC 500 processor family is available in a range of choices of memory, I/O capacity, instruction set, and communication ports that allow a user to tailor a control system to an exact application requirement. It should be understood by those skilled in the art that the implementation described herein utilizes the SLC 500 family of programmable controllers but could be easily implemented in any other control system platform, simply by modifying the control system interface mechanism.

In the actual embodiment of the invention described herein, the PLC 24 includes an expansion chassis having one or more available slots 25A-25N for receiving I/O modules. According to one actual embodiment of the present invention as shown in FIG. 1A, a Web server module 22 is provided as an I/O module that can be mounted within one of the slots 25A-25N of the PLC 24. As known to those skilled in the art, I/O modules communicate with the processor of the PLC 24 through a backplane interface. In this embodiment of the present invention, the Web server module 22 communicates with the memory and processor of the PLC 24 through such a backplane interface. As will be described below with respect to FIG. 1B, the Web server module 22 also communicate to the PLC through an RS-232 serial port, RS-485 port, or other type of network interface known to those skilled in the art. In this alternate embodiment of the invention, the Web server module 22 does not communicate with the PLC 24 over a backplane interface.

The Web server module 22 comprises a compact but fully functional Web server. As known to those skilled in the art, Web servers typically receive requests for Web pages and respond to those requests. In order to receive such requests, the Web server module 22 include an Ethernet port 30 for receiving requests via the Internet 20. As is well known to those skilled in the art, the Internet 20 comprises a collection of networks and routers that use the transmission control protocol/Internet protocol (“TCP/IP”) to communicate with one another.

The Internet 20 typically includes a plurality of local area networks and wide area networks that are interconnected by routers. Routers are special purpose computers used to interface one local area network or wide area network to another. Communication links within the local area networks be twisted wire pair, or coaxial cable, while communication links between networks utilize 56 KBPS analog telephone lines, 1 MBPS digital T-1 lines, 45 MBPS/T-3 lines, or other communications links known to those skilled in the art. Furthermore, computers such as the Web server module 22 can be remotely connected to either the local area networks or the wide area networks via a permanent network connection or via a modem 30 connected to the Web server module 22 through a RS-232 port 32, and the public switched telephone network 28. It will be appreciated that the Internet 20 comprises a vast number of such interconnected networks, computers, and routers. Additional details regarding the architecture and operation of the Web server module 22 will be described below with respect to FIGS. 1B, and 3-28.

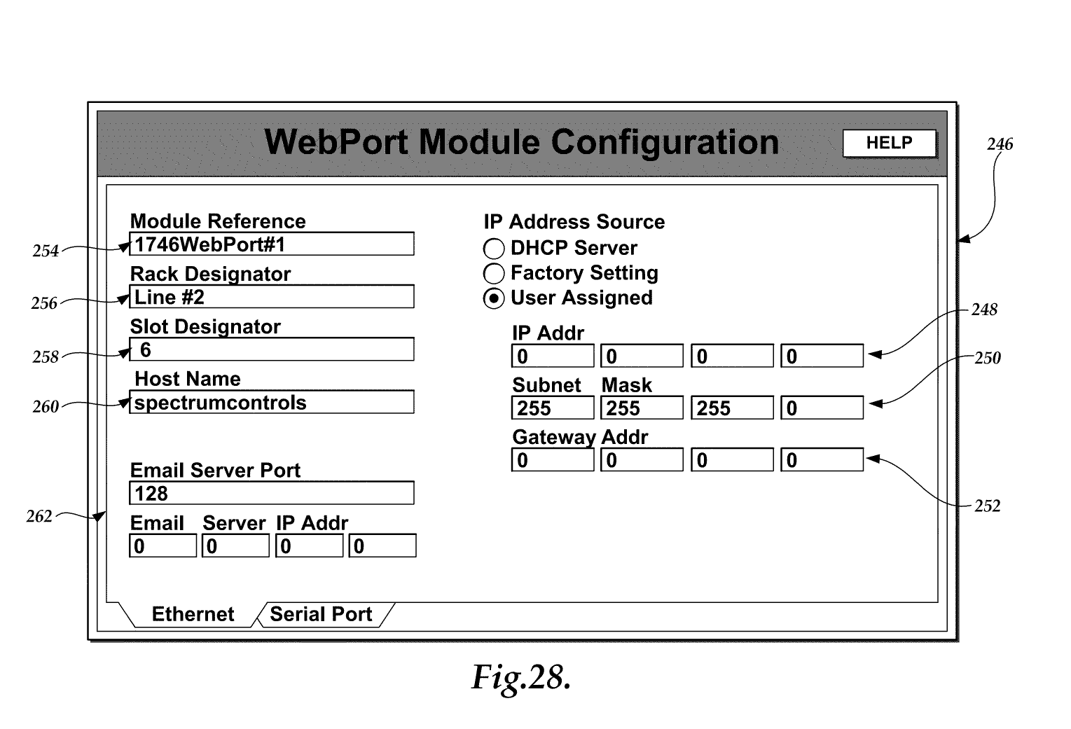

According to one aspect of the present invention, a remote computer 26 be utilized to connect to the Web server module 22 through the Internet 20. As described above, the remote computer 26 utilize a persistent connection to the Internet 20 or utilize a modem 30 to connect through the public switch telephone network 28 to the Web server module 22. The remote computer 26 comprises a standard personal computer and be utilized to perform several functions. First, the remote computer 26 be utilized to execute a Web server module configuration application. The Web server module configuration application comprises an application program that provides an easy-to-use interface for creating the Web site stored in the Web server module 22. As will be described in greater detail below, the Web server module configuration application 48 creates a non-markup language Web site database that describes the Web site served by the Web server module 22. When a user has completed creation of the Web site, the Web server module configuration application transmits the Web site database to the Web server module 22. The Web site database then be used by the Web server module 22 to dynamically generate markup language Web pages in response to requests. Additional details regarding the Web server module configuration application 48 will be provided below with respect to FIGS. 28-34.

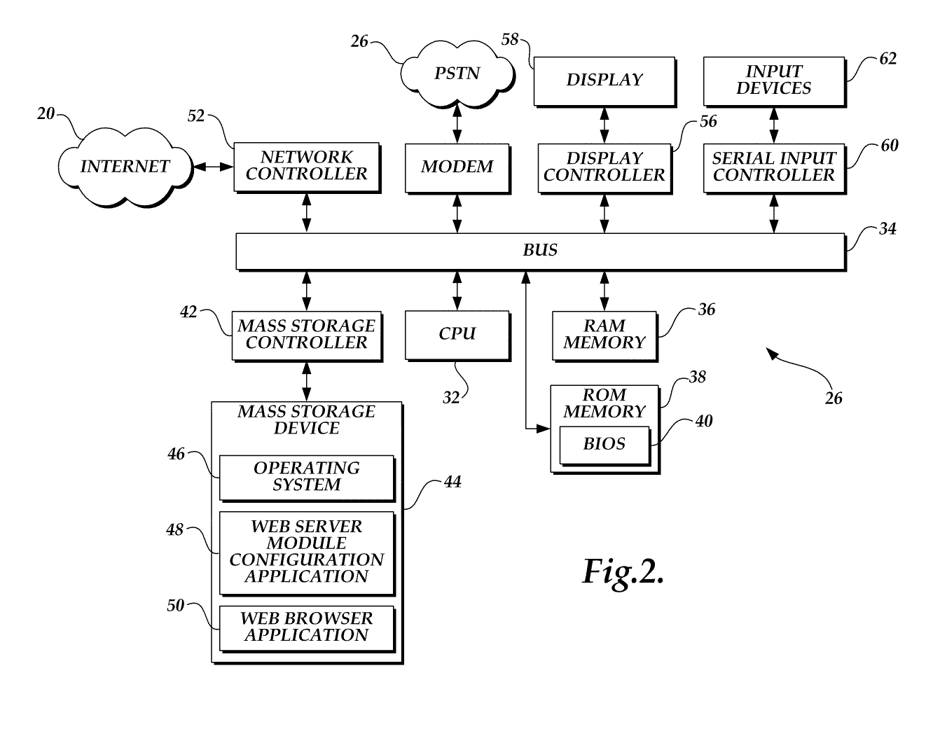

The remote computer 26 also be utilized to access the Web site available from the Web server module 22. The remote computer 26 utilize a standard Web browser application program, such as INTERNET EXPLORER® available from MICROSOFT CORPORATION, or NETSCAPE NAVIGATOR® available from NETSCAPE. The remote computer 26 can request and receive Web pages generated by the Web server module 22 in a conventional fashion. No additional software or application programs need to be installed on the remote computer 26 in order to request, receive, and display the Web pages. Additional details regarding the architecture and operation of the remote computer 26 will be provided below with respect to FIG. 2.

Turning now to FIG. 1B another illustrative operating environment for the present invention will be described. According to this embodiment of the present invention, the PLC 24 is equipped with an RS-232 port 23 as known to those skilled in the art. The RS-232 port 32 of the Web server module 22 is utilized to create a connection to the RS-232 port 23 of the PLC 24. It should be understood to those skilled in the art that the RS-232 connection could also be any other type of communication mechanism, including an RS-485 or other parallel or serial communication medium to allow access between the Web server module 22 and the PLC 24. Through this serial port connection, the Web server module 22 can request and receive information regarding the status of the PLC 24. In this embodiment of the present invention, the Web server module 22 does not communicate with the processor or memory of the PLC 24 through a backplane interface. Rather, all such communication is performed through the serial port, or other network, connection. In this embodiment, the Web server module 22, or not, be mounted in one of the slots 25A-25N and may, or not, obtain power from the backplane. However, as stated above, no communication with the processor or memory of the PLC 24 is performed over the backplane. Those skilled in the art should appreciate that the operating environments set forth herein are illustrative and that other similar such environments will be apparent to those skilled in the art. Moreover, it should be appreciated that aspects of the Web server module 22 described herein apply equally to any Web server module, including embedded Web servers and standard Web servers that operate on personal computers, mainframes, or other types of computer systems.

Turning now to FIG. 2, an illustrative computer architecture for the remote computer 26 will be described. The computer architecture shown in FIG. 2 illustrates a conventional personal computer, including a central processing unit 32 (“CPU”), a random access memory 36 (“RAM”), a read-only memory (“ROM”) 38, and a system bus 34 that couples the memory to the CPU 32. A basic input/output system 40 (“BIOS”) containing the basic routines that help to transfer information between elements within the computer, such as during startup, is stored in the ROM 38. The computer further includes a mass storage device 44 for storing an operating system 46 and application programs.

The mass storage device 44 is connected to the CPU 32 through a mass storage controller 42 connected to the bus 34. The mass storage device 44 and its associated computer-readable media, provide non-volatile storage for the computer. Although the description of computer-readable media contained herein refers to a mass storage device, such as a hard disk or CD-ROM drive, it should be appreciated by those skilled in the art that computer-readable media can be any available media that can be accessed by the remote computer 26. By way of example, and not limitation, computer-readable media comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer. This definition of computer-readable media also applies to the media contained within the Web server module 22 described herein.

A user enter commands and information into the remote computer 26 through input devices 62, such as a touch screen, a scanner, a keyboard, or a mouse. Other input devices include a microphone, keyboard, joystick, game pad, satellite dish, or the like. These and other input devices 62 are often connected to the CPU 32 through a serial input controller 60 that is coupled to the system bus 34, but be connected by other interfaces, such as a game port or a universal serial bus (“USB”). A display 58 also be driven by a display controller 56 connected to the system bus 34. In addition to the display 58, the remote computer 26 include other peripheral output devices not shown in FIG. 2, such as speakers connected through an audio adapter, or a printer.

As described briefly above, the remote computer 26 operate in a networked environment using logical connections to a Web server module 22 through the Internet 20. The remote computer 26 connect to the Internet 20 through a network controller 52. Alternatively, the remote computer 26 include a modem (not shown) and use an Internet service provider (“ISP”) to establish communications with the Internet 20. It will be appreciated that the network connections shown are illustrative and other means of establishing a communications link between the remote computer 26 and the Web server module 22 be used.

A number of program modules be stored in the mass storage device 44 and RAM 36, including an operating system 46 such as the WINDOWS NT® operating system from MICROSOFT® CORPORATION of Redmond, Wash. The mass storage device 44 and RAM 36 also store a Web browser application 50. The Web browser application 50 comprises a conventional Web browser application such as MICROSOFT′S INTERNET EXPLORER® or NETSCAPE NAVIGATOR®. As will be described in greater detail below, the Web browser application 50 be utilized to navigate a Web site provided by the Web server module 22.

The mass storage device 44 and RAM 36 also store a Web server module configuration application 48. The Web server module configuration application 48 provides a user interface for designing and creating the Web site that is served by the Web server module 22. Rather than require a user to program in a markup language, the Web server module configuration application 48 allows a user to create a Web site by providing selections on a number of display screens. The Web server module configuration application 48 stores the user-made selections in a Web site database and transmits this database to the Web server module 22. The Web server module 22 then utilizes the contents of the Web site database to dynamically generate markup language pages when a request is received. Additional details regarding the operation of the Web server module configuration application 48 will be described below with reference to FIGS. 28-34.

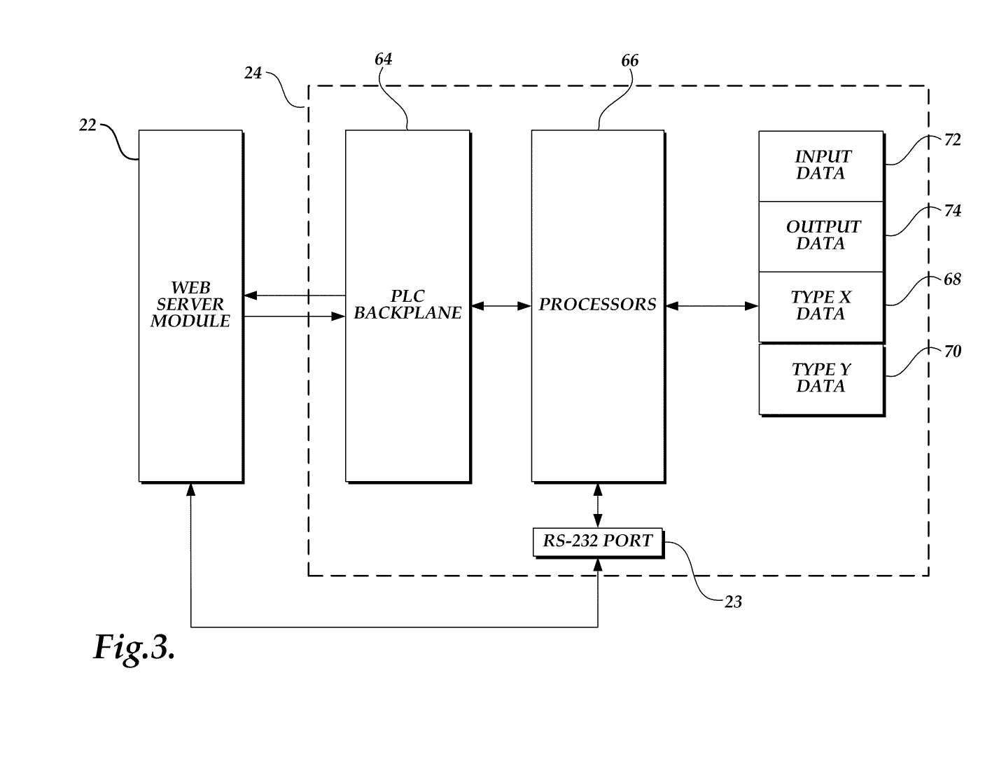

Turning now to FIG. 3, an illustrative architecture for a PLC 24 utilized in an actual embodiment of the present invention will be described. As known to those skilled in the art, a typical PLC 24 comprises a backplane 64 for communicating with I/O modules such as the Web server module 22. The backplane 64 comprises a bus that accommodate a number of such I/O modules. One or more processors 66 communicate with I/O modules via the backplane 64. The processors 66 typically include a CPU and memory means for storing programs and other data regarding operation of the PLC 24 such as counters, etc. According to the actual embodiment of the present invention described herein, the Web server module 22 access the processor 66 through an RS-232 port 23, or other communication medium as previously described, instead of accessing the processor 66 through the backplane 64. According to the embodiment of the present invention described herein, through either the backplane or other network interface, the Web server module 22 has access to both input 72 and output 74 PLC data. Through accessing this input and output data, the Web server module gains access to all data types within the PLC. Such data types be referred to generically herein as Type X data 68 or Type Y data 70.

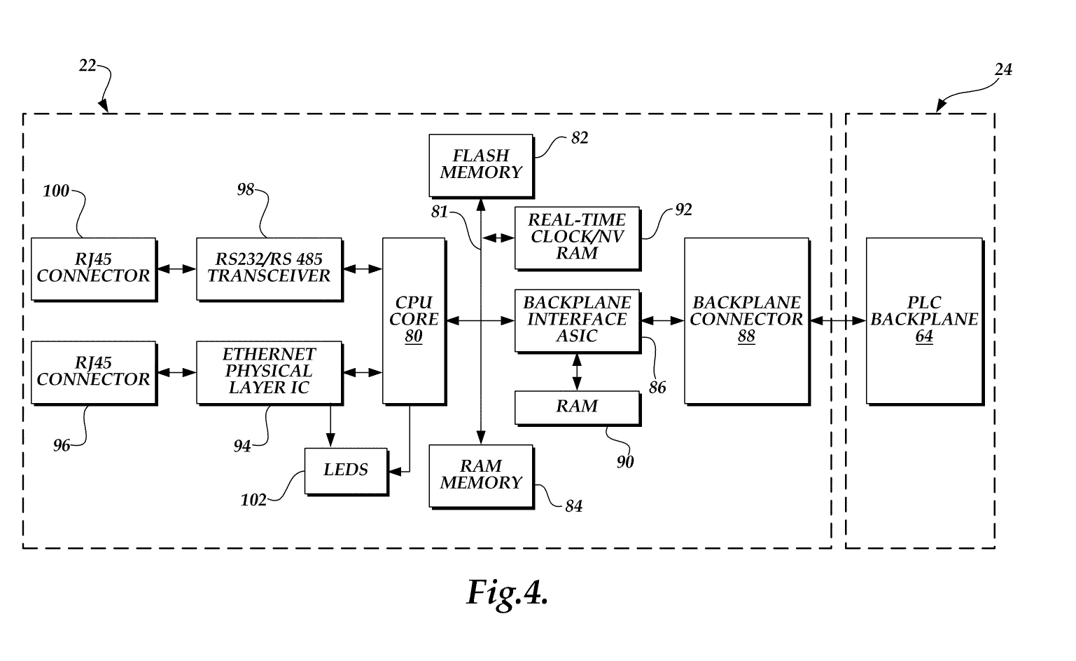

Turning now to FIG. 4, an illustrative computer architecture for a Web server module 22 utilized in an actual embodiment of the present invention will be described. In general, the Web server module 22 comprises a CPU core, an Ethernet port, an RS-232/RS-485 port, backplane interface circuitry, a power supply, and light-emitting diodes (“LEDs”) for status information. The block diagram shown in FIG. 4 shows these blocks of the Web server module 22 and their interconnections.

The CPU core 80 provides the controller, code memory, data memory, and a real time clock with battery-backed non-volatile RAM. According to the actual embodiment of the invention described herein, the CPU core 80 comprises a NET SILICON NET+ARM-40 application specific integrated circuit (“ASIC”). This ASIC is a highly-integrated circuit based on an ARM-7 32 bit processor, and includes access to several peripherals. In particular, the CPU core 80 includes a 32-bit RISC industry standard ARM 7 processor, two asynchronous serial ports with all handshaking signals, a DRAM controller with glueless DRAM interface, glueless flash memory interface, 15 general purpose 32-bit registers, IEEE 802.3 compliant 10 base-T/100 base-TX MAC Controller with MII interface, and additional features known to those skilled in the art. Other similar CPU cores are known to those skilled in the art and be utilized to implement aspects of the present invention.

Firmware for controlling the operation of the Web server module 22 as well as the Web server application itself reside in flash memory 82. According to the actual embodiment of the invention described herein, 4 512 K×16 flash integrated circuits are used to obtain the quantity of code space required. The architecture arranges the flash as two individual banks, of 512 K×32 each. A RAM memory 84 is also provided for general use. According to the embodiment of the present invention described herein, 2 4M×16 synchronous DRAMs provide the general use RAM memory. These devices sit on the system bus and are configured as a 4 M×32 wide SDRAM memory space.

An integrated real time clock and non-volatile RAM 92 is also provided. According to the actual embodiment of the present invention described herein, a single device providing a 32K×8 low power SRAM, year 2000-compliant real-time clock, 32.768 kHz crystal, and a 10-year lithium battery is utilized. This device is addressed like a standard 8-bit SRAM and resides on the system bus. The real-time clock information is located in the top eight memory locations of the SRAM.

A backplane interface ASIC 86 is also provided to enable the CPU core 80 access to the PLC 24 backplane 64. An electrical connection is made between the Web server module 22 and the PLC backplane 64 through the use of a backplane connector 88 which is electrically connected to the backplane interface ASIC 86. The ASIC require an external SRAM 90 for data storage. The SRAM 90 acts as a shared RAM that can be utilized by both the PLC 24 and the Web server module 22.

An RS-232/RS-485 transceiver 98 is also electrically connected to the CPU core 80. The RS-232/RS-485 transceiver 98 supports full handshaking in its RS-232 configuration to allow connectivity to external hardware such as modems and printers. The RS-485 hardware is also supported for connectivity to PLCs 24 via RS-485 based protocols. An RJ45-type connector 100 is also provided for connecting to external devices.

An Ethernet physical layer integrated circuit (“IC”) 94 is also connected to the CPU core 80 for providing an IEEE 802.3 compliant 10 base-T/100 base-TX Ethernet communications port. This port has four major components: an integrated circuit to handle the 10 base-T/100 base-TX physical layer requirements, an isolation transformer to handle a 1500v RMS isolation requirement, a precision 25 mHz crystal for Ethernet timing, and an RJ45 connector 96 for the physical connection to a twisted pair cable.

The Web server module 22 is supplied power from a +5 volt backplane power supply according to one embodiment of the invention. According to another embodiment of the invention, the Web server module 22 receives power from an external +5 volt power supply. Additionally, LEDs 102 provide status information regarding the operation of the Web server module 22 and the Ethernet physical layer IC 94.

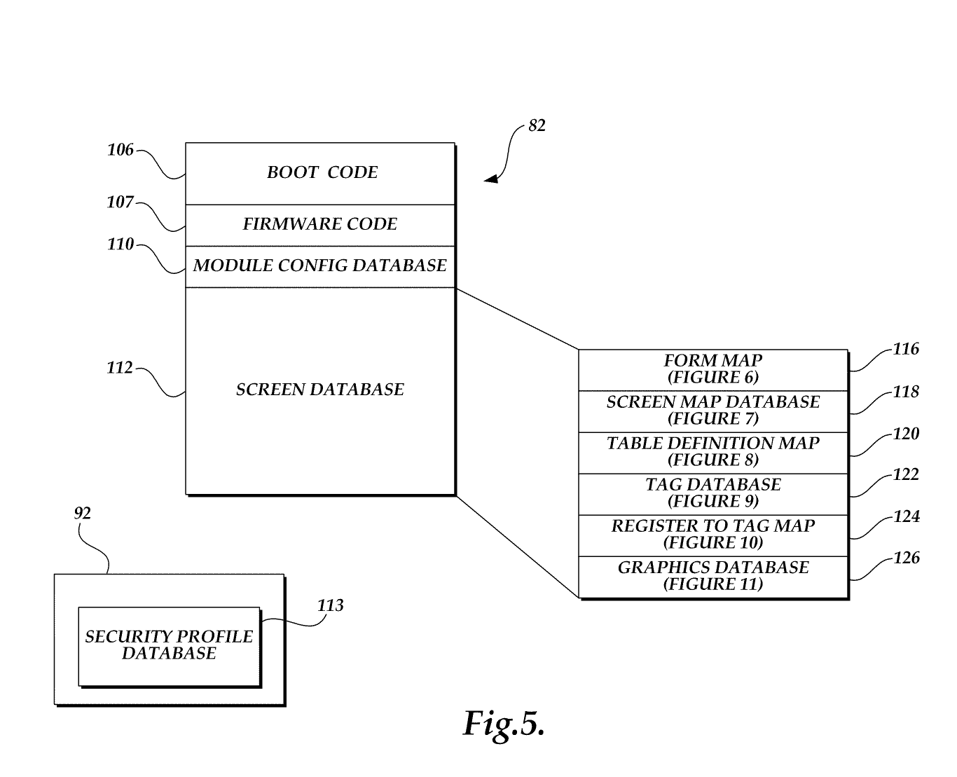

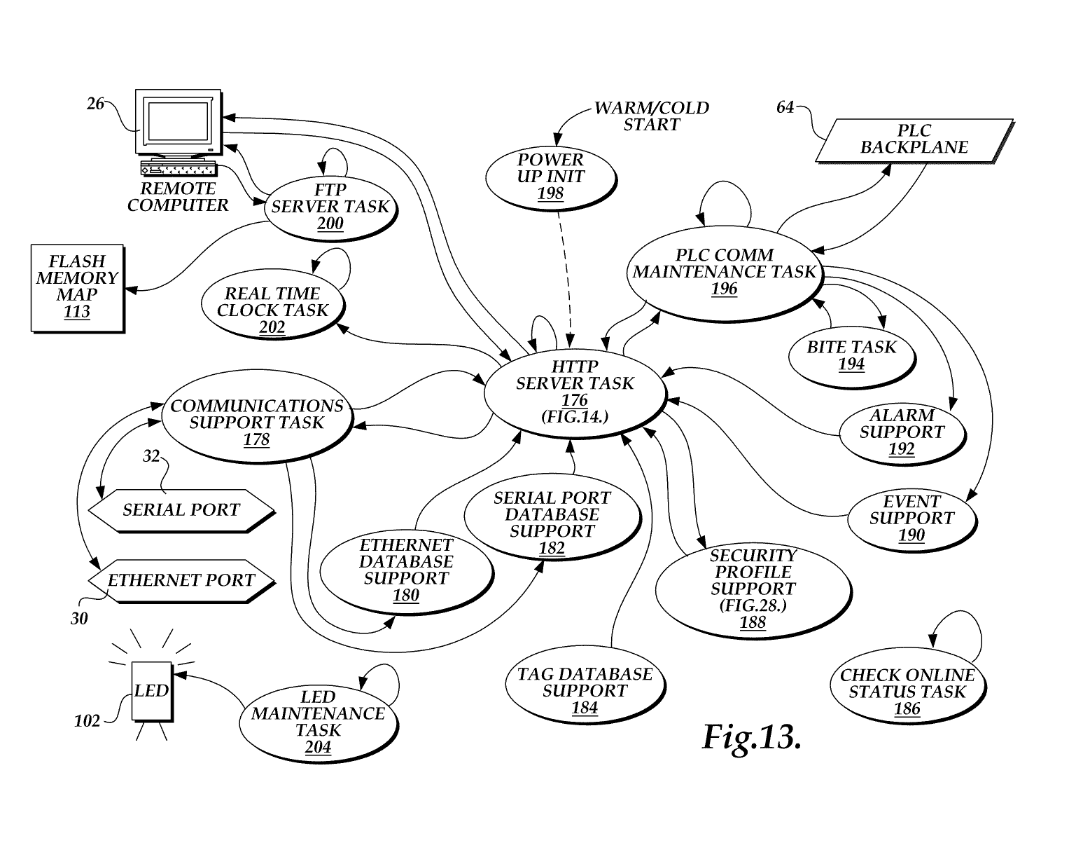

Turning now to FIG. 5, the contents of the flash memory 82 contained within the Web server module 22 will be described. According to one embodiment of the present invention, the flash memory 82 contains boot code 106. The boot code 106 contains hardware power-up processing code. The flash memory 82 also includes firmware code 107. The firmware code 107 comprises the firmware that supports the functionality of the Web server module 22 and contains both the operating system and the application program code. The operation of this application program is described below with reference to FIGS. 13-27.

The flash memory 82 also contains a module configuration database 110. This database includes an Ethernet database providing information for the Ethernet controller and a serial port database that provides information regarding the configuration of the serial port. The flash memory 82 also includes a Web site database, also called a screen database 112, that fully defines the Web site to be served by the Web server module 22. As described in greater detail below, the application program executing on the Web server module 22 utilizes the contents of the screen database 112 to dynamically generate markup language Web pages.

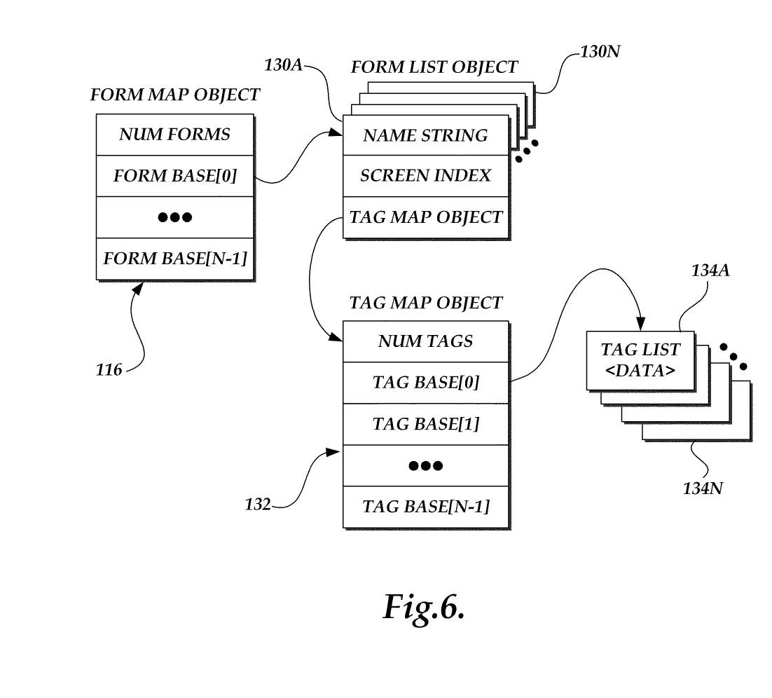

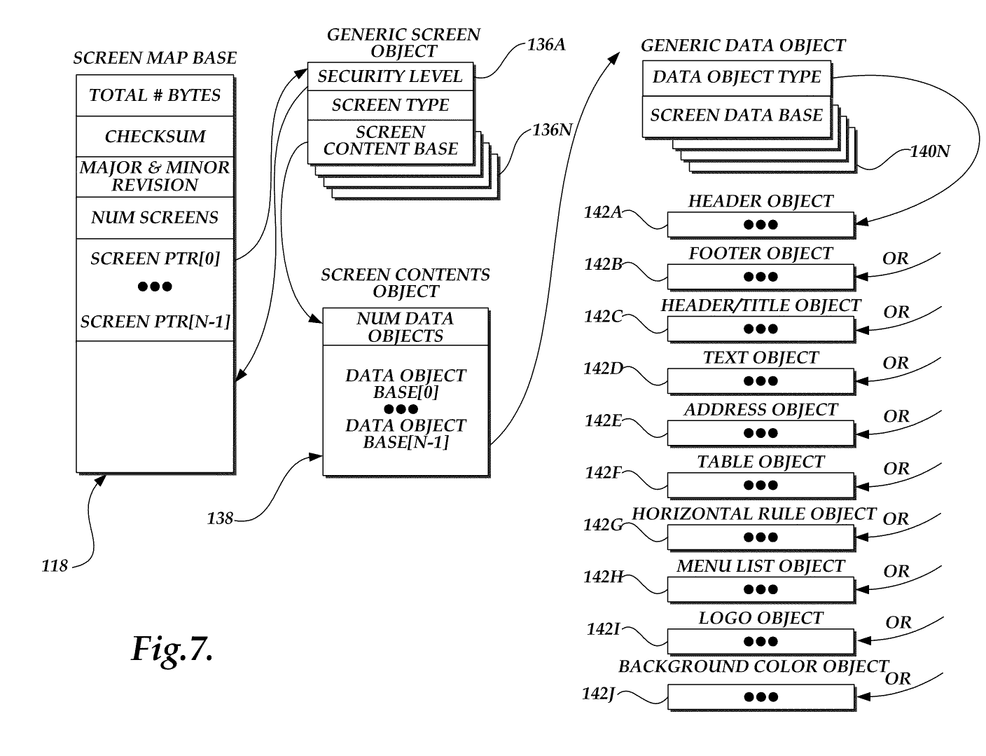

The screen database 112 comprises a form map 116, a screen map database 118, a table definition map 120, a tag database 122, a register to tag map 124, and a graphics database 126. The form map is utilized by the Web server module 22 to process incoming form posts or other similar write requests. Those incoming posts can be in the form of user inputs to the Web server via the browser, such as button presses or update requests. Additional details regarding the form map 116 are described below with reference to FIG. 6. The screen map database 118 contains data for creating each of the screens provided by the Web server module 22 based on a page request via the browser. The screen map database 118 is described below in greater detail with reference to FIG. 7.

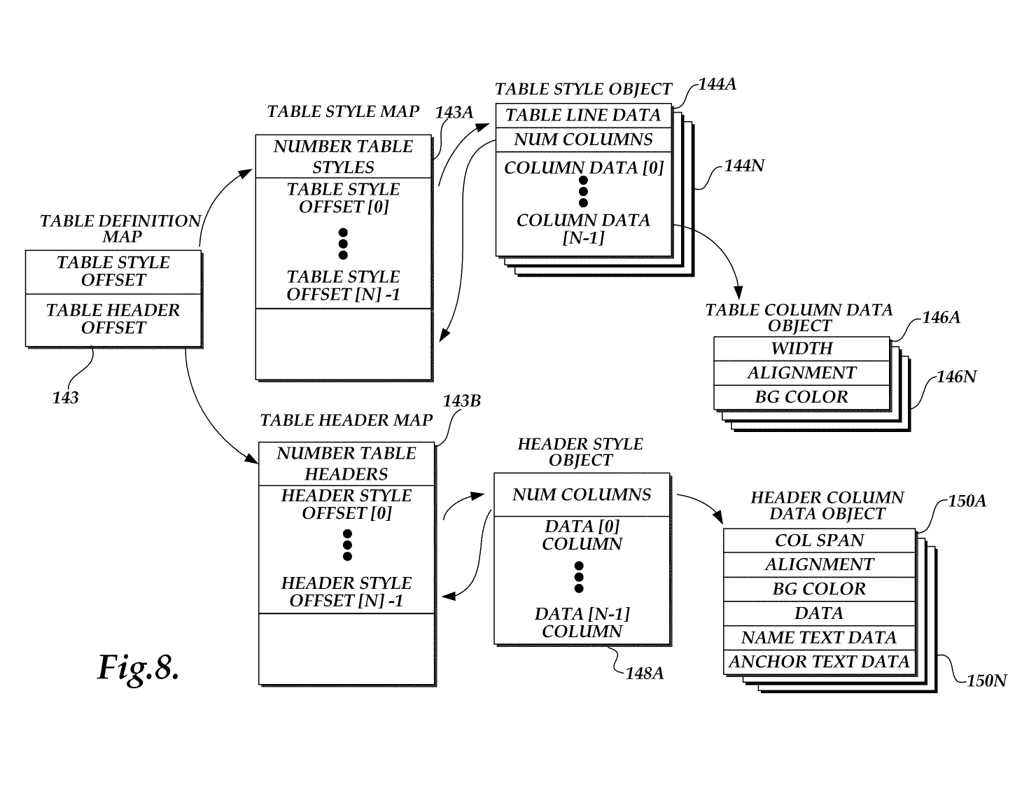

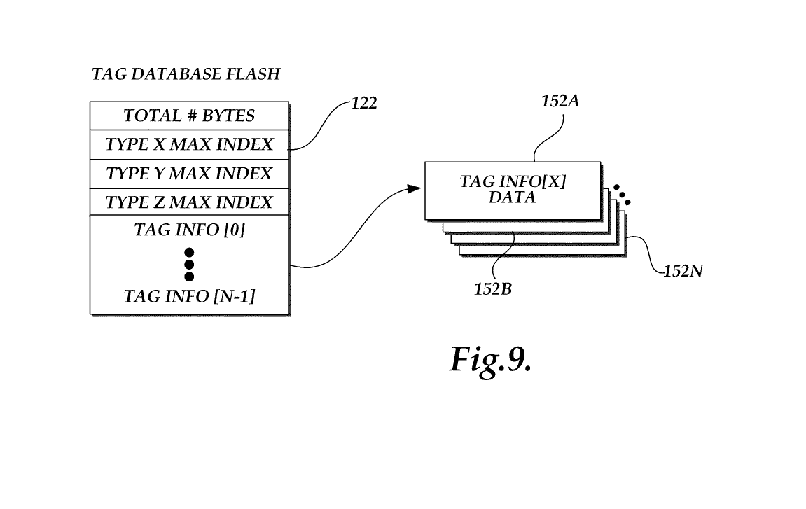

The table definition map 120 contains information for the style and header details associated with each table defined and included within a page, defined in the screen map database. The table definition map 120 is described below with reference to FIG. 8. The tag database 122 contains type and attribute information for each defined tag. A tag comprises an association between a memory location contained within the PLC 24 and a data item contained within the Web server module 22. By defining tags, easy access be provided to data contained within the PLC 24. Additional details regarding the tag database 122 are described below with reference to FIG. 9.

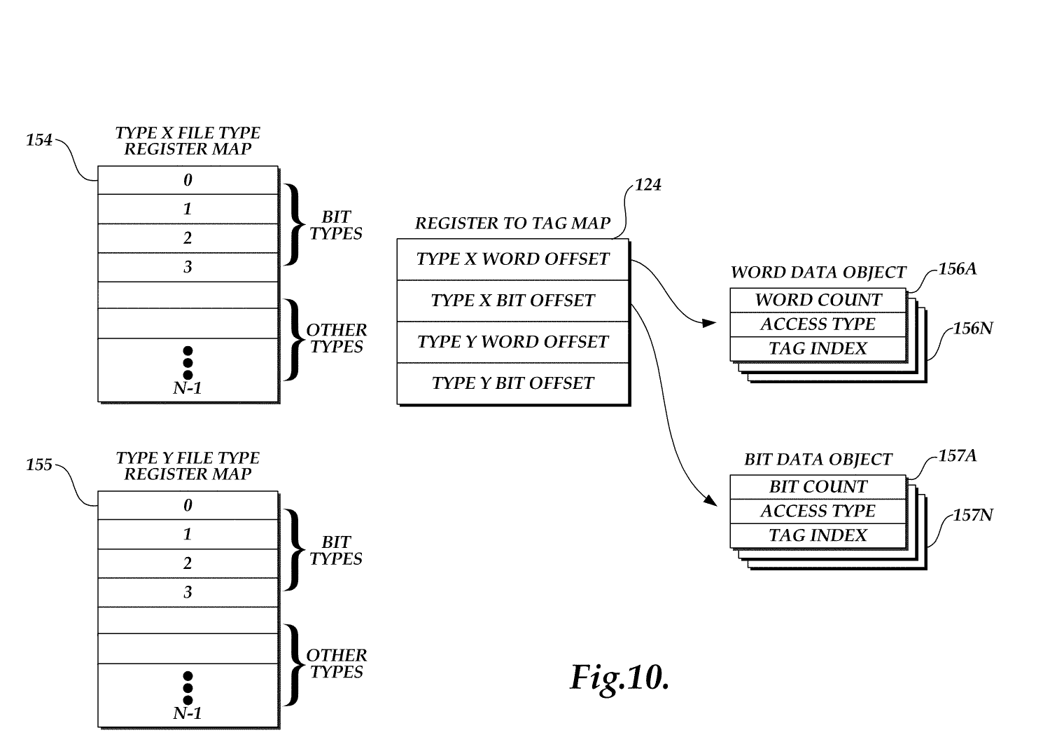

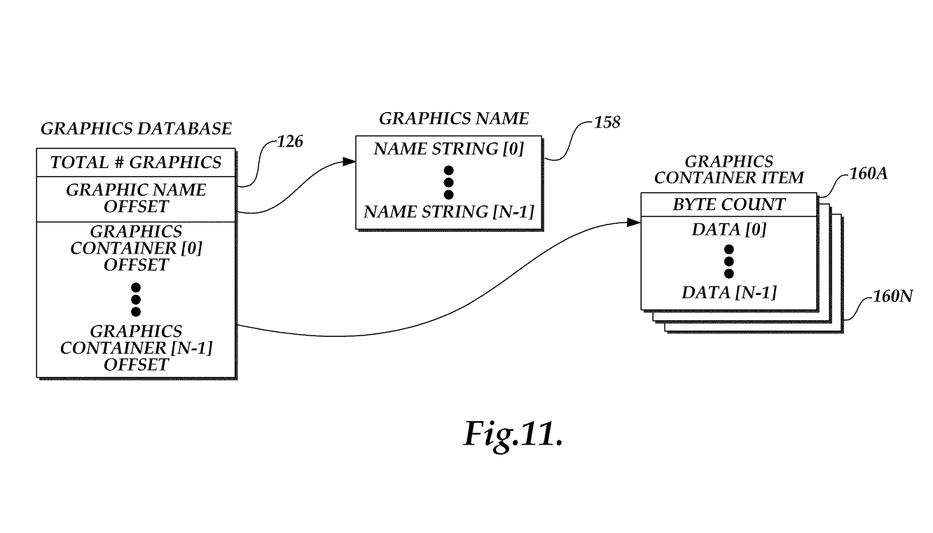

The register to tag map 124 comprises a mapping of the PLC to Web server type data words to the tag database 122. The register to tag map 124 is used by the firmware to effectively retrieve incoming data from the PLC 24. Additional details regarding the register to tag map 124 are described below with reference to FIG. 10. The graphics database 126 is a mapping of the logos and other graphics accessed in conjunction with the screen map database 118 to provide graphic images on markup language pages. Additional details regarding the graphics database 126 will be described below with reference to FIG. 11. It should be appreciated by those skilled in the art that the contents of the databases including the screen database 112 are created by the Web server module configuration application 48 on the remote computer 26 and downloaded to the Web server module 22. As shown in FIG. 5, the screen database 112 comprises several different databases that are utilized to generate the Web site provided by the Web server module 22. Each of the databases contained within the screen database 112 is dynamically sized and downloaded to the Web server module 22 as a single file.

Turning now to FIG. 6, additional details regarding the form map database 116 will be described. Each table within a given screen of the Web site has an associated form posting mechanism, whose form include several tags. For form posting, this mechanism allows a mapping from form name, to the tag indices of the data values associated with that form. When form posting comes in, using the form map database 116, the entry name and value be retrieved to post. To accomplish this functionality, the form map 116 contains a form map object which identifies the number of forms and an offset from the beginning of the form map base to the base of the form item object indexed by a given number. The form map offset comprises a pointer to a form list object 130A. The form list object 130 includes a character string associating a form post name for the given form, a screen index to correlate the form posting with the generating screen map index to the screen database 112, and a tag map object 132 that defines specific form post functionality allowed for the given form via tag list 134A definitions. The form post functions defined in the tag list 134A be tag data write entries, or button presses, or other form post functionality defined for the form map object. Each form post function contains tag list data specific to its function type.

Turning now to FIG. 7, an illustrative screen map database 118 will be described. As mentioned above, the screen map database 118 is defined by a user via the Web server module configuration application 48 executing on the remote computer 26. The screen map database 118 is downloaded to the flash memory of the Web server module 22 as a part of the screen database 112. The screen map database 118, along with the form map 116, the table definition map 120, the tag database 122, the register to tag map 124, and the graphics database 126 completely define and enable the contents of the various screens of the Web site provided by the Web server module 22 and their linked pages.

As shown in FIG. 7, the screen map database 118 comprises a data structure that indicates header information for the screen map database 118, including an entry identifying the number of screens contained within the screen map database 118. The screen map database 118 also includes a number of offsets. Each of these offsets point to a generic screen object 136A-136N. The generic screen object 136A defines the screen type for the screen and contains an offset to the screen contents object 138. The screen contents object 138 specifies a number of features for the particular screen. Each data object is defined by it's data object type 140A, which defines the specific data content of that object 140A-140N to be placed on the screen. For instance, the screen contents object 138 include a data object 140A header title 142C, and a data object 140A background color 142J. Each of the page objects 142A-142J identifies a particular type of object to be placed on the particular screen. For instance, the screen contents object 138 contain multiple data objects 140A-140N that correspond to one or more of a header object 142A, a footer object 142B, a header/title object 142C, a text object 142D, an address object 142E, a table object 142F, a horizontal rule object 142G, a menu list object 142H, a logo object 1421, or a background color object 142J. By providing references to a number of the page objects 142A-142I within a given screen contents object 138, an entire screen be defined. As will be described in greater detail below, the screen map database 118 be parsed by the Web server module 22 to dynamically generate the markup language necessary to display the screen on a standard Web browser.

Referring now to FIG. 8, an illustrative table definition map 143 will be described. As discussed briefly above with reference to FIG. 5, the table definition map 143 is downloaded to the Web server module 22 as a part of the screen database 112. A table definition map 143 contained in the screen map database 118 contains a table style map offset 143A and a table header map offset 143B. Within the table style map 143A, each defined table contains a table style object 144A, that then defines multiple table column data objects 146A-N. Similarly, within the table header map 143B, each defined table contains a header style object 148A, that then defines multiple header column data objects 150A-N. The table column data object 146A and the header column data object 150A contain data specific to the HTML generation of the respective table header or table data column style entries, such as width, alignment, color, and anchor definitions. In this manner, the information required for data access table renderings be defined completely for each column header and data content, and reused for multiple data tables.

Turning now to FIG. 9, an illustrative tag database 122 will be described. The tag database 122 is downloaded to the Web server module 22 as a part of the screen database 112. The tag database 122 contains type and attribute information for every tag defined within the Web server module 22. As described briefly above, a tag comprises an association between a memory location contained within the PLC 24 and a data item contained within the Web server module 22. As will be described in greater detail below, the tag database 122 is accessed by many tasks executing within the Web server module 22, including a backplane interface mechanism, an alarm support task, an event support task, and an hyper-text transfer protocol (“HTTP”) server processing task.

As shown in FIG. 9, the tag database 122 includes a number of elements, including a maximum type X index, a maximum type Y index, and a maximum type Z index. The maximum indices define the highest register index of each particular accessible type of data. The tag database 122 also comprises a number of offsets to tag info data structures 152A-152N. The tag info data structures 152A-152N contain data describing a particular tag. For instance, the tag info data structure 152A include a definition of the type of input tag, the associated register index, a description of the access type, an access mask, a tag function description, a tag name, an alarm offset giving the base location of an alarm attribute object, and an event offset giving the base location of an event attribute object for the tag. Other types of data as known to those skilled in the art also be contained within the tag info data structure 152A.

As mentioned above, the tag info data structure 152A include an alarm offset and an event offset. The alarm offset is a pointer to an alarm attribute object which defines conditions upon which an alarm should be generated and other alarm specifications for the particular tag. For instance, an e-mail notification, a pager notification, or a printed report be generated when the value of a tag satisfies the condition set forth in the alarm attribute object. An event attribute object provide similar functionality for providing notifications that a particular event has occurred, for the particular tag.

Turning now to FIG. 10, an illustrative register to tag map 124 will be described. The register to tag map 124 is downloaded to the Web server module 22 as a portion of the screen database 112. The register to tag map 124 provides an association between incoming data from the PLC 24 and tag definitions within the tag database 122 of the screen database 112. Outgoing data from the Web server module 22 to the PLC 24 does not require such a map, by virtue of the information contained in the tag database 122 described above with reference to FIG. 9.

The purpose of the register to tag map 124 is to correlate register data incoming to the Web server directly to tag definitions defined by the user in the tag database 122. Of the data types accessible, there are single bit types, 8 bit types, 16 bit types, and 32 bit types, all which can be mapped into the shared RAM 90 associated with the backplane interface ASIC 86. Bit types are segmented to the first several registers of the type X file type register map 154. A similar type Y file type register map 155 exist. Multiple file type register maps exist as defined by the backplane or other communication interface definition and/or the PLC processor. The register to tag map 124 then includes offsets to word data objects 156A-156N and bit data objects 157A-157N, for each file type supported. The word data object map 156A defines the number of words used within the file type map, and for each 8 bits in the shared RAM 90 segmented for non-bit type usage (as shown in the type X file type register map 154 under ‘other types’), an entry exists defining the access type and the tag index. Similarly for the bit data object map 157A-157N, a definition of the number of words used for bits is provided, and then for each bit, an entry exists defining the access type and the tag index. This provides a correlation from the registers incoming to the Web server, to the tag database 122. When the data is read it can then be evaluated appropriately and placed in the local RAM 84.

Referring now to FIG. 11, an illustrative graphics database 126 will be described. As with the other databases described above, the graphics database 126 is downloaded to the Web server module 22 as a portion of the screen database 112. The graphics database 126 contains all of the graphics utilized in the Web pages to be served by the Web server module 22. The graphics database 126 is accessed through the HTTP server support mechanism described below.

The structure of the graphics database 126 comprises an element describing the total number of graphics, a graphics name offset, and a graphic container offset. The graphic name offset describes the offset from the beginning of the graphics database 126 to the base of the graphic name object 158. Similarly, the graphic container offset identifies the offset that, when added to the value of the base of the graphics database 126, will give the base to the graphics container object. In this manner, entries in the graphics database 126 point to a graphic name 158 and graphic container 160A.

The graphic container 160A identifies the total number of bytes for a graphic and actually includes the data defining the graphic. In this manner, each of the graphics to be utilized in the Web site provided by the Web server module 22 be contained in a single database. The graphics database 126 is parsed by the Web server module 22 when responding to requests for Web pages and the appropriate graphic is extracted. This process will be described in greater detail below.

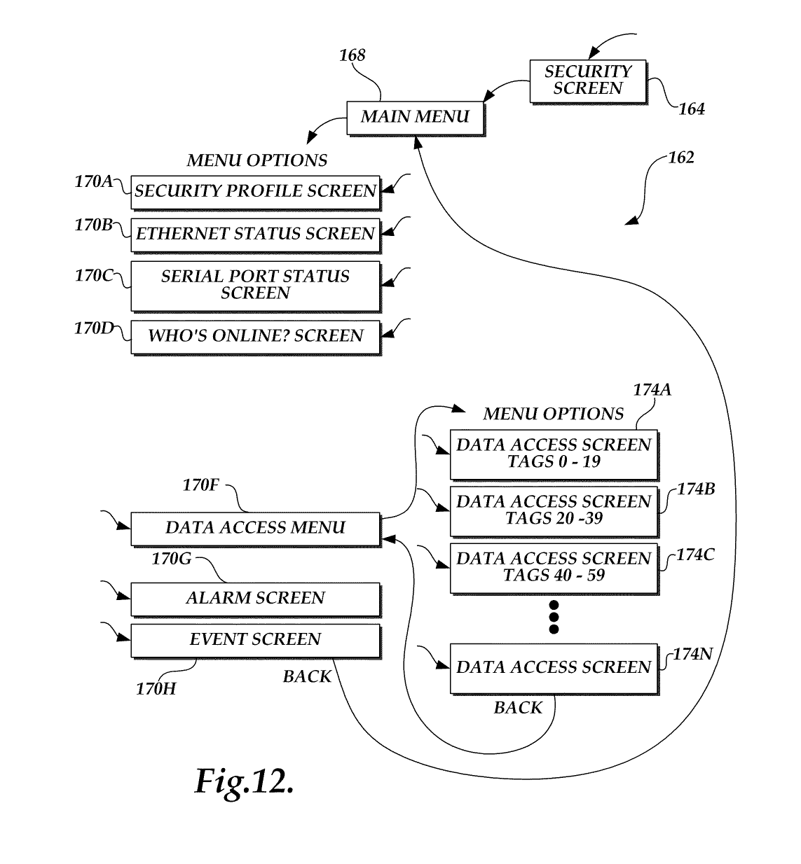

Turning now to FIG. 12, an illustrative Web site provided by the Web server module 22 in an actual embodiment of the present invention will be described. In a default configuration, the Web server module 22 contains a Web site previously defined and downloaded to the module. The predefined Web site 162 includes basic data access features in an easy to comprehend and intuitive format. The style defined for the pages of the predefined Web site 162 is consistent throughout all pages, easy to read, and informal. The predefined Web site 162 includes a security screen 164, followed by a main menu screen 168. The predefined Web site 162 is provided to give a user of the Web server module 22 a building block to create a specific application. The user utilize the Web server module configuration application 48 to modify the contents of the predefined Web site 162 to suit their particular needs.

The security screen 164 provides an authentication mechanism to determine whether a user is authorized to view the predefined Web site 162. The user be asked to provide a login name and password in order to gain access to the predefined Web site 162. Once the user has been authenticated, the user is presented with a main menu screen 168. The main menu screen presents links to other menu screens and data screens. In particular, the main menu screen 168 provides links to a security profile screen 170A, an Ethernet status screen 170B, a serial port status screen 170C, a “Who's on-line?” screen 170D, a data access menu 170F, an alarm screen 170G, and an event screen 170H.

The security profile screen 170A be utilized by system administrators to change the access rights for the users of the Web server module 22. The Ethernet status screen 170B provides basic status information for the Ethernet connection as well as status of the physical Ethernet port on the Web server module 22. The serial port status screen 170C provides similar information for the serial port of the Web server module 22. The “Who's on-line?” screen 170D provides the identity of other users currently logged into the Web server module 22. The alarm screen 170G provides access to the current alarm table resident in the Web server module 22. The alarm table includes information such as the state, tag name, condition, value, and acknowledgment information for defined alarms. Similar information for events also be obtained through the event screen 170H. A link from the screens 170A-170H exists to return the user back to the main menu screen 168.

The data access menu 170F provides access to data access screens 174A-174N. Data access screens 174A-174N provide table-oriented read/write data, 20 tags defined per screen, in this example. If the user wishes to add or modify the tag definitions, the table definitions, the various page contents, the graphics, or the linkages, the Web server module configuration application 48 must be utilized. Those skilled in the art should appreciate that the predefined Web site 162 comprises a baseline Web site for the Web server module 22. It is intended that a user will utilize the Web server module configuration application 48 to customize the predefined Web site 162 to a specific application. Moreover, the types of screens described as being included with the predefined Web site 162 include other types of data, status, and administration screens known to those skilled in the art.

Referring now to FIG. 13, a state diagram will be described that illustrates the top level operation of the Web server module 22. As shown in FIG. 13, a number of tasks execute in parallel to provide the functionality of the Web server module 22. In particular, a file transfer protocol (“FTP”) server task 200 listens for an FTP client connection request. The FTP server task 200 can receive requests from the remote computer 26 for such a connection. If such a connection is established and the user of the remote computer 26 has the appropriate security clearance, the FTP server task 200 can send and receive data to and from the remote computer 26 to update the contents of the flash memory 82. The FTP server task 200 typically communicates with the Web server module configuration application 48 to provide this functionality.

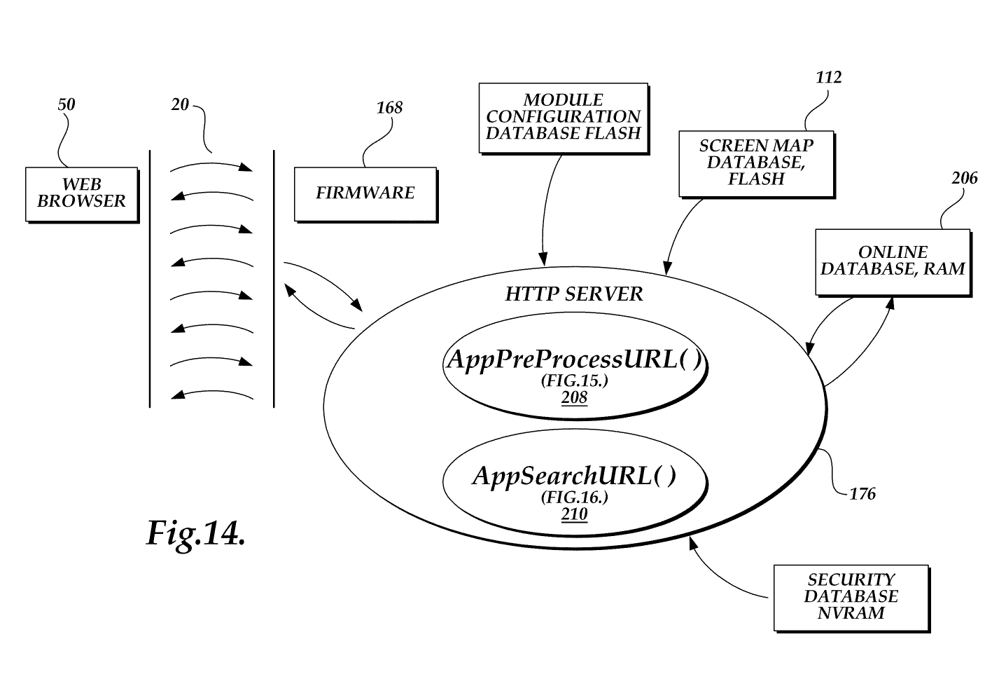

A power up initialization task 198 is executed in response to a warm or cold start of the Web server module 22. The power up initialization task 198 initializes all necessary memory and code for the operation of the Web server module 22. When the power up initialization task 198 has completed, the HTTP server task 176 is executed. The HTTP server task 176 provides the main functionality for dynamically generating markup language pages in response to validated HTTP requests. The HTTP server task 176 performs such functionality both for outgoing markup page data and for incoming form post requests. The HTTP server task 176 is described in greater detail below with reference to FIG. 14.

The PLC communications maintenance task 196 provides functionality for interfacing with the PLC backplane 64. The PLC communications maintenance task 196 provides a read data task that maintains incoming data from the PLC 24 to the Web server module 22. The read data task continually accesses the incoming Web server registers from the PLC 24, compares them to their last current state, and moves data appropriately. If the particular registers are defined as alarms or events, then notifications are issued to the appropriate alarm or event queue through the PLC communications maintenance task 196 read cycle. The PLC communications maintenance task 196 also includes a write data task. This task takes messages from a write message queue and writes the properly formatted outgoing data through the backplane communication mechanism for transmission to the PLC 24.

A bite task 194 is also provided for manufacturing testing and verification of the Web server module 22. Alarm support 192 is also provided to maintain a first-in/first-out alarm queue in NVRAM. Support functions include adding an alarm, acknowledging an alarm, deleting an alarm, and providing alarm queue data to the HTTP server task 176. Similarly, event support 190 functionality is also provided to maintain a first-in/first-out event queue. Support functions include adding an event, deleting an event, and providing event data to the HTTP server task 176. A check online status task 186 is also provided that determines whether users are currently online with the Web server module 22. The check online status task 186 maintains an online database identifying those users that are currently online. If a request or response is not received from a user within a predefined period of time, the check online status task 186 will change an entry in an online database to indicate that the user is no longer online. The security profile support mechanism 188 accesses both the security profile database 113 and the online database to grant access to the Web server module 22 based upon incoming data requests. Tag database support 184 is also provided to allow easy access to the information within the tag database 122 stored in flash memory and the values for each tag stored in RAM. An LED maintenance task 204 is also provided that executes to periodically update the LEDs 102 of the Web server module 22. Serial port database support 182 and Ethernet database support 180 are also provided for providing access to the serial port data table and the Ethernet data table, respectively. A communication support task 178 is also provided to support sending and receiving messages through the serial port 32 or the Ethernet port 30. A real time clock task 202 is also provided for maintaining the internal time and date as needed for by the Web server system.

Referring now to FIG. 14, the HTTP server task 176 will be described. The HTTP server task 176 is executed as a part of the firmware 168. The HTTP server task 176 receives requests from a Web browser 50 over the Internet 20 for Web pages, graphics, and other objects. In order to respond to these requests, the HTTP server task 176 consults the security profile support mechanism 188, and the screen map database 112. Using the screen map database 112, the HTTP server task 176 can dynamically generate the markup language comprising the requested data. The HTTP server task 176 also consult the security profile support mechanism 188 to validate the identity of the requesting client. In general, the HTTP server task 176 receives page requests and form postings as input, and outputs both static and dynamic HTML data to validated users.

As known to those skilled in the art, the HTTP protocol is typically stateless. This means that when a client browser issues a request, the Web server issues a response, and the session is terminated. No state information is typically maintained about a client browser request. However, the Web browser 50 utilized in the actual embodiment of the present invention described herein utilizes a script to periodically request a page from the HTTP server task 176. In this manner, the HTTP service task 176 through the check online status task 186 can maintain the state of each connection.

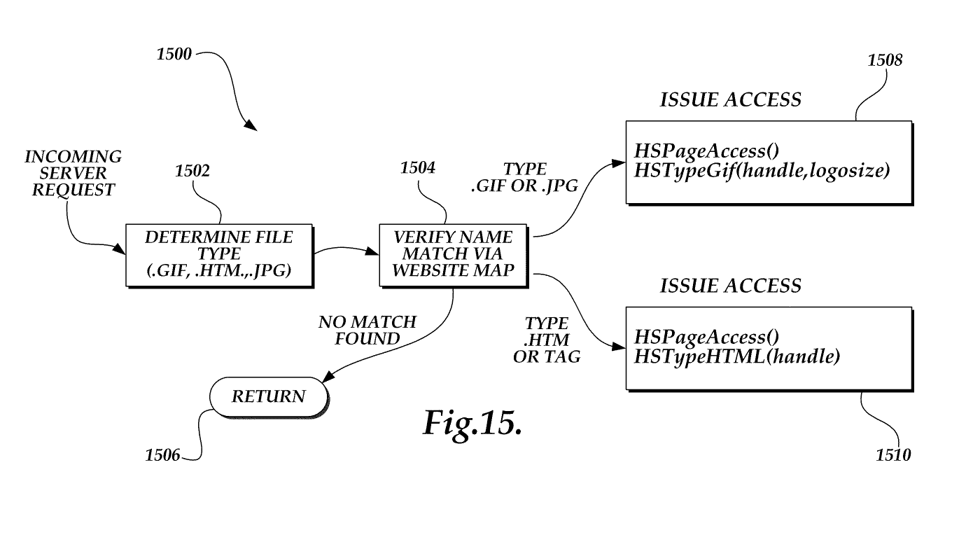

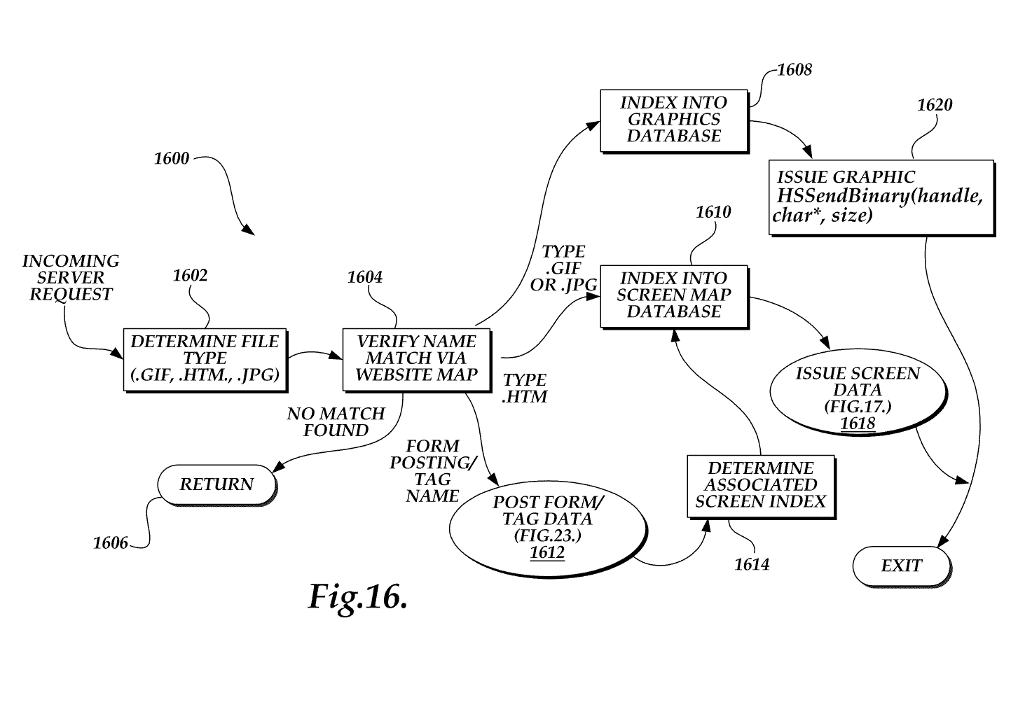

The HTTP server task functionality in the current implementation is based upon a package commercially available from NETSILICON, INC., and is an application available with the NET+OS operating system functional with the NET+ARM-40 microprocessor ASIC. The HTTP server task 176 generally comprises two interface routines. The use of the two “APP PRE PROCESS URL” and “APP SEARCH URL” allow the application to initialize, validate, and reply to a browser page content or form post request. The “APP PRE PROCESS URL” routine 208 authenticates the request and initializes the HTTP server for the proper MIME type content for the requested data. The “APP PRE PROCESS URL” routine 208 will be described below with reference to FIG. 15. The “APP SEARCH URL” routine 210 provides a mechanism to completely validate and match the data request, searches and accesses the appropriate screen database component, and issues the appropriate response for the request. The “APP SEARCH URL” routine 210 will be described below in greater detail with respect to FIG. 16.

Turning now to FIG. 15, the “APP PRE PROCESS URL” routine 208 will be described. This routine is illustrated by the state machine 1500. The state machine 1500 begins at state 1502, where an incoming server request is received. In response to receiving such a request, the file type of the request is determined. For instance, a determination is made as to whether the request comprises a request for an HTML file, a graphic (.GIF) file, or other type of file. Other types of files include but are not limited to Applets, .TEXT, .JPEG, .PICT, .TIFF, .PNG, .XBM, .WAV and .AU file types. From state 1502, the state machine 1500 transistions to state 1504. At state 1504, the Web site map is consulted to determine whether the requested file exists within the screen database 112. If the requested file does not exist within the screen database 112, the state machine 1500 transitions from state 1504 to state 1506.

If, at state 1504, it is determined that the requested file does exist within the screen database 112 and that the requested file type is a graphic file, the state machine 1500 transitions to state 1508. At state 1508, access is initialized within the HTTP server for the .GIF type, for the requesting handle. If, at state 1504, it is determined that the requested file is contained in the screen database 112 and the requested file is a markup language file or a tag, the state machine 1500 transitions to state 1510, where access is initialized properly within the HTTP server for the .HTM type, for the requesting handle. Turning now to FIG. 16, the “APP SEARCH URL” routine 210 will be described. This routine is illustrated through the state diagram 1600. The state machine 1600 begins at state 1602, where an incoming server request is received. At state 1602, the file type is determined for the incoming server request. From state 1602, the state machine transitions to state 1604, where a determination is made as to whether the requested file is contained within the screen database 112. If the requested file is not within the screen database 112, the state machine 1600 transitions to state 1606, where it returns. If the requested file is a graphic file, the state machine 1600 transitions to state 1608, where an index is made into the graphics database 126. The state machine then transitions from state 1608 to 1620, where the graphic is issued in response to the request.

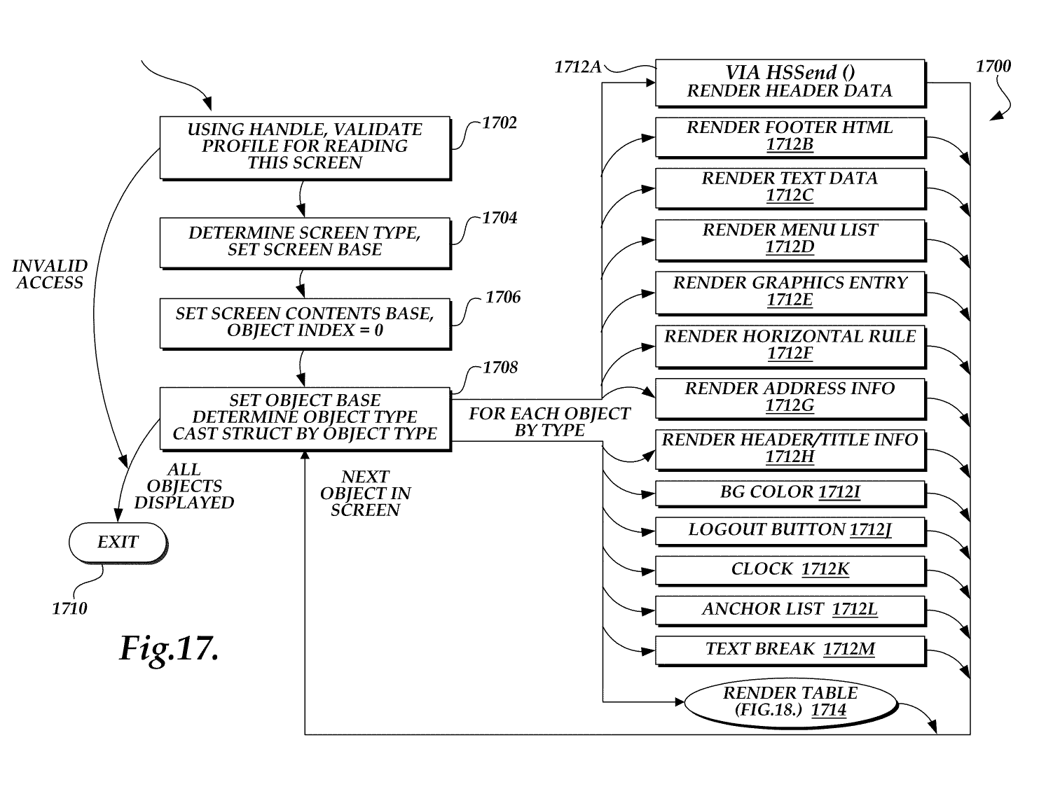

If, at state 1604, it is determined that the request is for a markup language file, the state machine 1600 transitions to state 1610. At state 1610, an index is made into the screen map database 118 to locate the requested file. The state machine 1600 then transitions to state 1618 where the requested file is issued. An illustrative routine for issuing the screen data is described below with reference to FIG. 17.

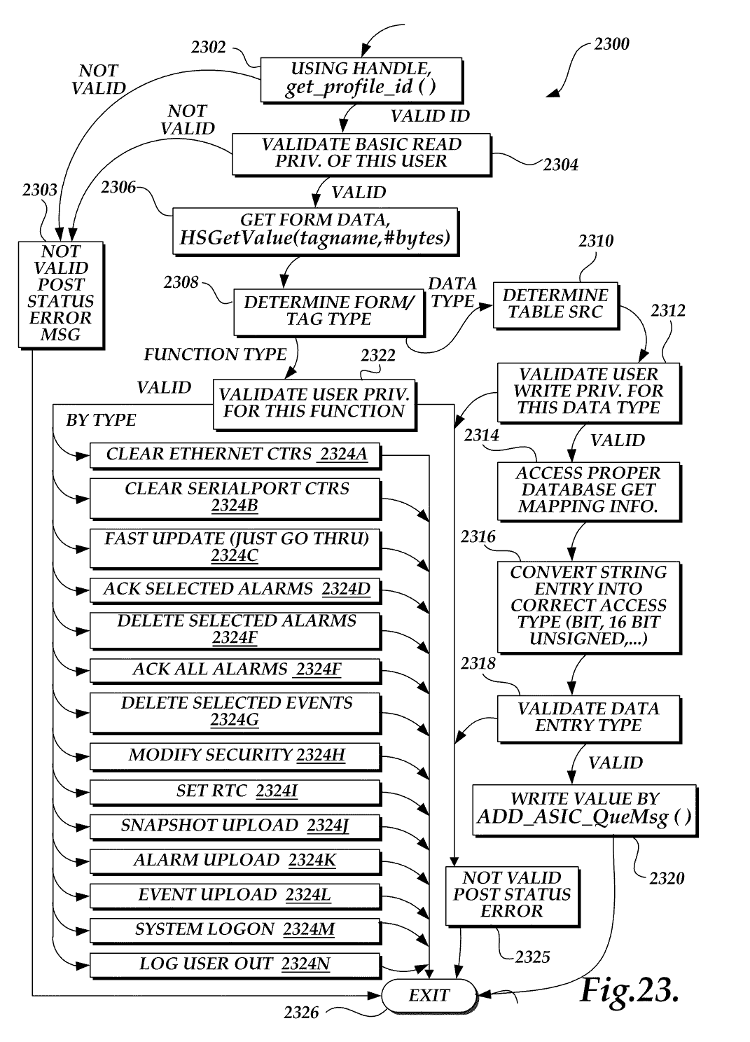

If, at state 1604, it is determined that the incoming server request comprises a form posting, the state machine 1600 transitions to state 1612. At state 1612, the posted form is then further validated and placed on a queue to be written to memory. An illustrative routine for posting form and tag data is described below with reference to FIG. 23. From state 1612, the state machine 1600 transitions to state 1614, where the associated screen index for the form posting is identified. The routine then transitions to state 1610 where an index is made into the screen map to locate the appropriate table. From state 1610 the state machine 1600 transitions to state 1618 where the screen data corresponding to the form posting is issued. As mentioned above, an illustrative routine for issuing screen data is described below with reference to FIG. 17.

Referring now to FIG. 17, an illustrative state machine 1700 will be described for issuing screen data. The state machine 1700 begins at state 1702, where the user requesting the screen data is validated. If the requesting user has appropriate access rights to view the screen, the state machine 1700 continues to state 1704. If the user does not have appropriate access rights, the state machine 1700 transitions from state 1702 to state 1710, where it ends.

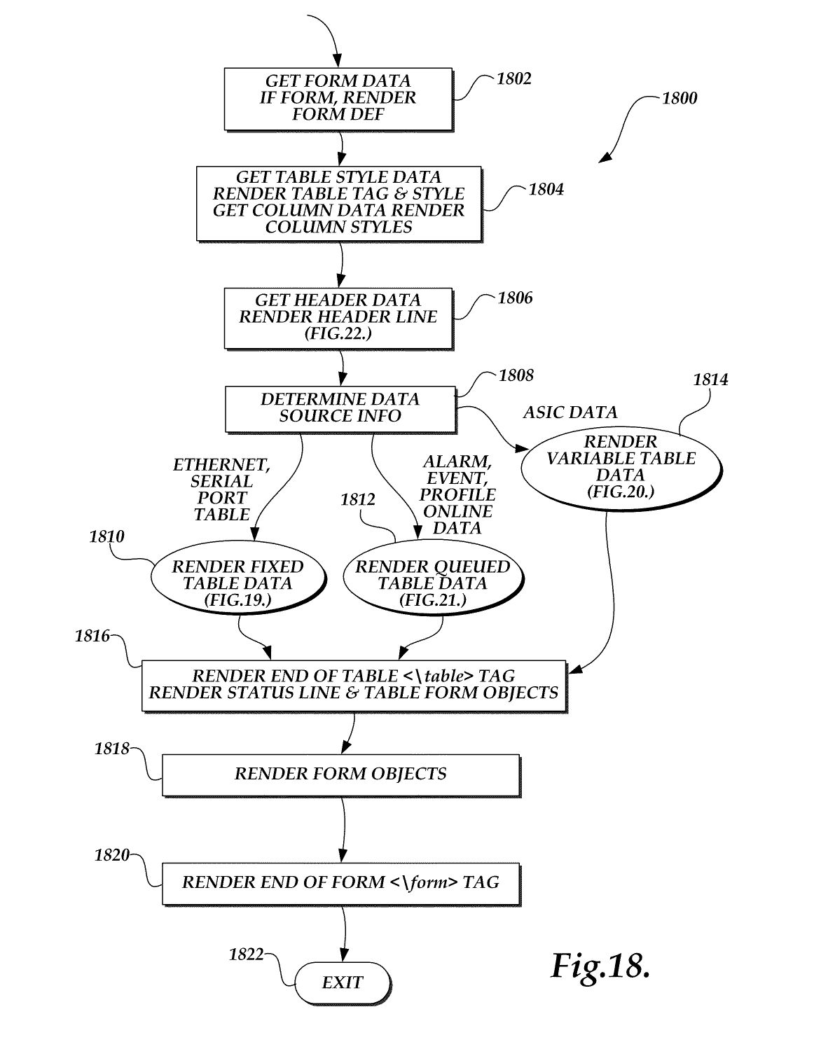

At states 1704, 1706, and 1708, the appropriate screen and contents for the requested page are identified within the screen map database 118. Once the location of these objects have been identified, the individual objects contained on the requested screen be rendered. The rendering takes place at steps 1712A-1712M, where the HTML for a header, footer, text, menu, graphic, horizontal rule, address, title, background color, clock, anchor list, text break, or logout button, respectively are rendered. Additionally, a table be rendered at state 1714. An illustrative routine for rendering a table is described below with reference to FIG. 18. Once a particular object has been rendered at one of steps 1712A-1712M, the state machine 1700 transitions back to state 1708. At 1708 a determination is made as to whether all objects for the screen have been rendered. If all objects have not been rendered, the state machine 1700 continues to one of blocks 1712A-1712M, or 1714, where additional objects are rendered. This process continues until the HTML for each object on a screen has been rendered. Once the HTML for all of the objects has been rendered, the state machine 1700 transitions from state 1708 to state 1710, where it ends.

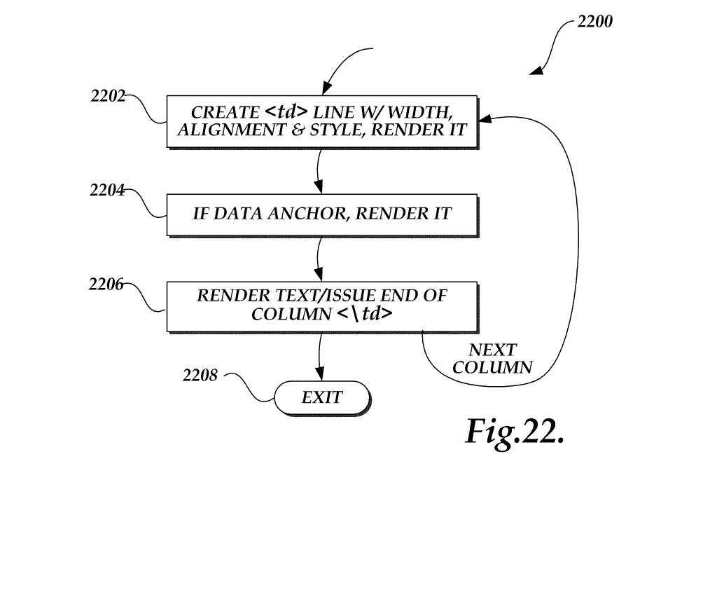

Referring now to FIG. 18, an illustrative state machine 1800 will be described for rendering the contents of a table. The state machine 1800 begins at state 1802, where form data is obtained if the table includes form posting support. The HTML for the form definition is also rendered at state 1802. From state 1802, the state machine 1800 continues to state 1804, where the table style data is obtained. Using this data, the HTML for the table tag and style are rendered. The state machine 1800 then continues to state 1806, where the column data is obtained and the HTML is rendered, and where the header data is obtained and the HTML for the header line is rendered. An illustrative routine for rendering the header line is described below with reference to FIG. 22.

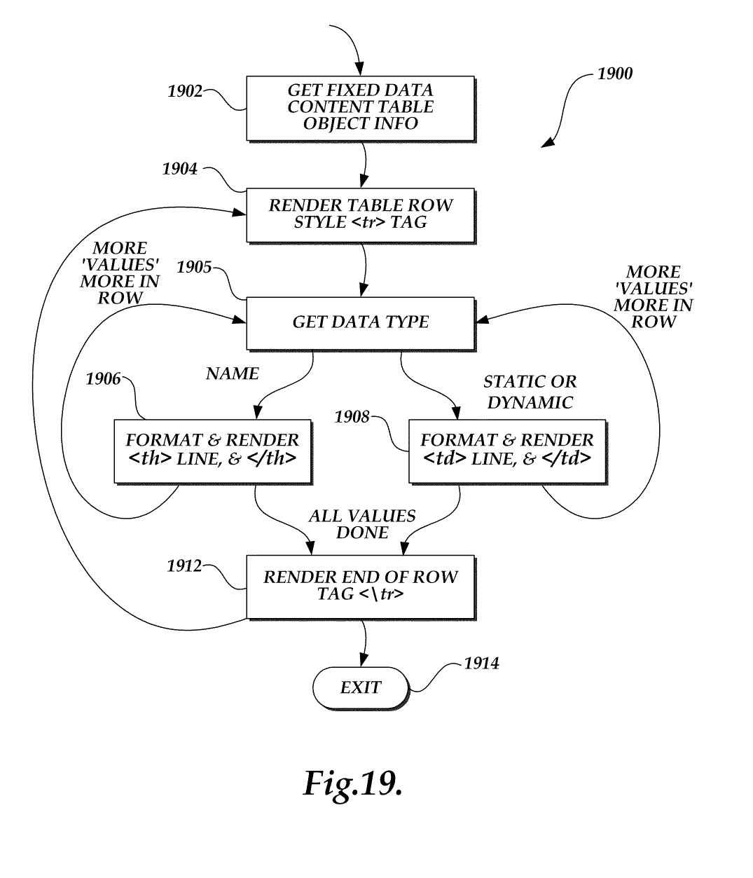

From state 1806, the state machine 1800 continues to state 1808, where the type of table to be rendered is determined. If an Ethernet or serial port status table is to be rendered, the state machine 1800 transitions to state 1810, where the HTML for a fixed table data comprising the Ethernet status or serial port status table is rendered. An illustrative routine for rendering HTML for a fixed table is described below with reference to FIG. 19.

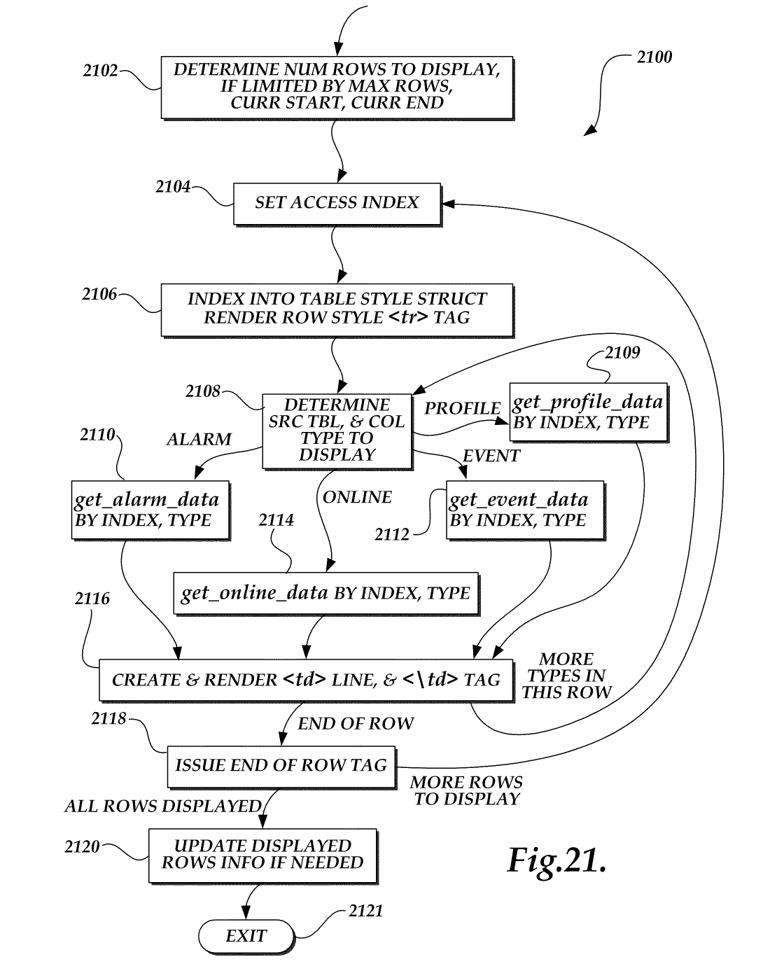

If, at state 1808, it is determined that an alarm, event, security profile, or online status table is to be rendered, the state machine 1800 transitions to state 1812. At state 1812, HTML for queued table data is rendered. An illustrative routine for rendering queued table data is described below with reference to FIG. 21.

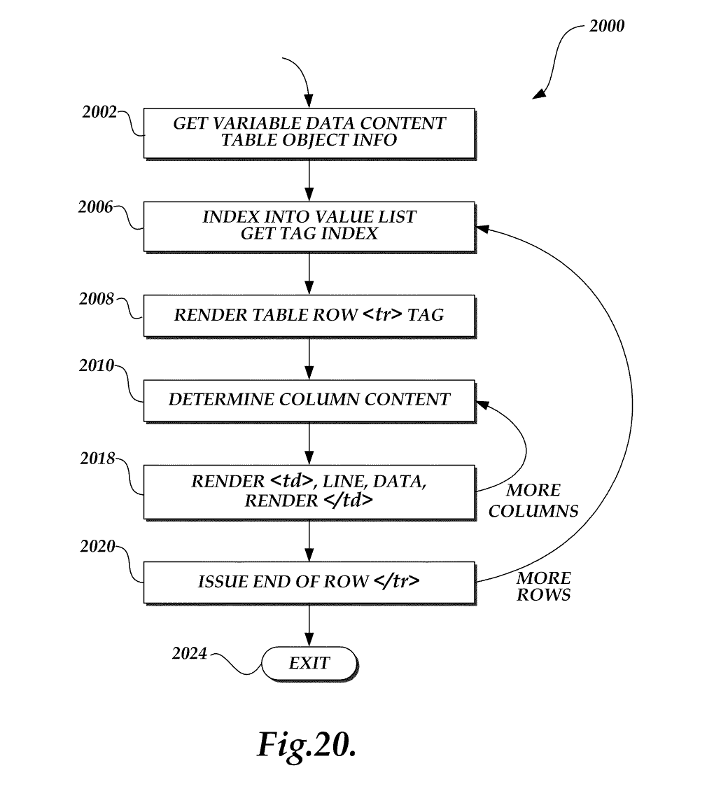

If, at state 1808, it is determined that the requested table is a table containing ASIC data, the state machine 1800 transitions to state 1814. At 1814, HTML for a table having variable data is rendered. An illustrative routine for rendering variable table data is described below with reference to FIG. 20. From states 1810, 1812, and 1814, the state machine 1800 transitions to state 1816. At state 1816, the markup language for the status line, and form objects associated with the table such as buttons, as well as the end of table are all rendered. At state 1818, any form objects not connected to the table are rendered, and at state 1820, the markup language indicating an end of form is rendered. The state machine 1800 then transitions to state 1822, where it ends.

Referring now to FIG. 19, an illustrative state machine 1900 will be described for rendering fixed table data. The state machine 1900 begins at state 1902 where the content for the table is obtained. The state machine 1900 continues to state 1904 where the HTML for the table row style tag is rendered. The state machine then continues to state 1905 where the data type is retrieved and evaluated. From state 1905, the state machine 1900 transitions to state 1906 if the content to be rendered is a fixed name. If, at state 1905, the content to be rendered is static or dynamic data, then state machine 1900 transitions to state 1908, where data is formatted and the HTML is rendered. From states 1906 and 1908, the state machine 1900 continues to state 1905 if additional values within the given row are to be rendered. If the entire row has been issued, then the state machine 1900 continues to state 1912, where the HTML for the end of row tag is rendered. If additional rows are to be rendered, the state machine 1900 returns to state 1904. If all values have been rendered or a row limit is met, the state machine 1900 continues from state 1912 to state 1914, where it ends.

Referring now to FIG. 20, an illustrative state machine 2000 will be described for rendering the HTML for a table having variable data. As described above with reference to FIG. 18, HTML for such a table is rendered when a request is received for a table containing ASIC data. The state machine 2000 begins at state 2002, where data is retrieved regarding the variable table data to be rendered. The state machine 2000 continues to state 2006, where an index is made into the tag database 122 to obtain a tag index. The state machine 2000 then transitions to state 2008, where an index is made into the table style structure contained within the table definition map 120. The row style for the current row is obtained from the table style structure. The table row tag is rendered.

From state 2008, the state machine 2000 transitions to state 2010, where the column width, alignment, and style data is obtained for the current column entry. From 2010, the state machine 2000 transitions to 2018, where the HTML for the current cell is rendered with the appropriate data. If additional cells need to be rendered, the state machine 2000 transitions back to state 2010, where additional cells are rendered as described above. If no additional cells need to be rendered in the current row, the state machine 2000 continues to state 2020. If additional rows are to be displayed, the state machine 2000 transitions back to state 2006. If all rows have been displayed, the state machine transitions from state 2020 to state 2024, where it ends.

Referring now to FIG. 21, an illustrative state machine 2100 will be described for rendering queued table data. As discussed above briefly with respect to FIG. 18, the state machine 2100 is utilized to render tables that include alarm, event, profile, and online status data. The state machine 2100 begins at block 2102, where the number of rows to display in the table is identified. The state machine 2100 then continues to state 2104, where an access index is set. From state 2104, the state machine 2100 continues to state 2106, where an index is made into the table style structure contained in the table definition map shown above in FIG. 8. The markup language for the row style is also rendered at state 2106.

From state 2106, the state machine 2100 transitions to state 2108 where the type of table to be displayed is identified. If an alarm table is to be displayed, the state machine 2100 transitions to state 2110, where the alarm data is retrieved. If an online status table is to be displayed, the state machine 2100 transitions to state 2114, where the online status data is retrieved. If the table to be displayed is an event table, the state machine transitions to state 2112, where the appropriate event data is retrieved. If the table to be displayed is a profile table, the state machine 2100 transitions to state 2109 where the profile data is retrieved.

From states 2110, 2114, 2112, and 2109, the state machine 2100 transitions to state 2116. At state 2116, the HTML tag for a cell in the appropriate table is rendered. If additional data types in the current row exist to be rendered, the state machine transitions back to state 2108. If the end of row has been reached, however, the state machine 2100 transitions to state 2118, where an end of row tag is issued. If more rows exist to be displayed, the state machine transitions back to state 2104. If, however, all rows have been displayed, the state machine transitions from state 2118 to state 2120 where which rows have been displayed are updated as necessary. The state machine 2100 then transitions to state 2121, where it ends.

Referring now to FIG. 22, an illustrative state machine 2200 will be described for rendering the HTML for a data table header. The state machine 2200 begins at block 2202, where the markup language for a header style, including width, alignment, and style data is rendered. The State machine 2200 then continues to state 2204, where the HTML for a data anchor, if any, is also rendered. The state machine 2200 then continues to state 2206 where the HTML for header text is also rendered. The HTML for an end of column tag is also rendered at state 2206. If additional columns remain to be rendered, the state machine 2200 transitions back to state 2202. If all columns have been rendered, the state machine 2200 transitions to state 2208, where it ends.

Referring now to FIG. 23, an illustrative state machine 2300 will be described for receiving and processing HTTP form posts, both functions and data write entries. The state machine 2300 begins at state 2302, where a profile ID for the user requesting to post is obtained. If the profile ID is invalid, the state machine 2300 transitions to state 2303 where an error message is provided to the user. If the profile ID is valid, the state machine 2300 transitions to state 2304 where the user privileges are validated. If the user does not have appropriate privileges, the state machine 2300 transitions to state 2303, where an error message is provided to the user. If the user does have appropriate access privileges, the state machine 2300 transitions to state 2306 where form data is retrieved. The state machine 2300 then transitions to state 2308 where the type of form is determined. If the form post is a submit data type, such as posting a value to be written to the PLC 24, the state machine 2300 transitions to state 2310. If, however, the form posting is of a function type, such as for clearing counters or acknowledging alarms, the state machine 2300 transitions from state 2308 to state 2322.

At state 2310, the source for the table to be posted is obtained. The state machine 2300 then transitions to state 2312, where the user privileges for the particular type of data to be posted is validated. If the user does not have valid privileges, the state machine 2300 transitions to state 2325 where an error message is generated. If the user does have valid privileges, the state machine 2300 transitions from state 2312 to state 2314. At state 2314, the mapping information mapping the posted tag data to the appropriate memory register within the PLC 24 is obtained. The state machine then transitions to state 2316, where the posted string data is converted into an appropriate numerical type to be posted. The state machine 2300 then transitions to state 2318 where the data type is validated. If the data type is invalid, the state machine transitions to state 2325 where an error is provided. If the data type is valid, the state machine transitions to state 2320, where the posted data is placed in a write queue to be written to the backplane interface ASIC 86 and, subsequently, to the PLC 24. From state 2320, the state machine 2300 transitions to state 2326, where it ends.

If, at state 2308, it is determined that the form type is for a function posting, the state machine 2300 transitions from state 2308 to state 2322. At state 2322, the privileges for the user are validated. If the user does not have valid privileges, the state machine 2300 transitions to state 2325 where an error message is provided. If the user's privileges are valid, the state machine transitions to one of states 2324A-2324N, depending on the type of posting made. The states 2324A-2324N correspond to posting of forms for clearing ethernet counters, clearing serial port counters, fast update, acknowledging selected alarms, deleting selected alarms, acknowledging all alarms, deleting selected events, modifying security privileges, setting a real time clock, uploading table contents, uploading alarm queue contents, uploading event queue contents, logging a user onto a session, or logging a user out of a session, respectively. From each of the states 2324A-2324N, the state machine 2300 transitions to state 2326, where it ends.

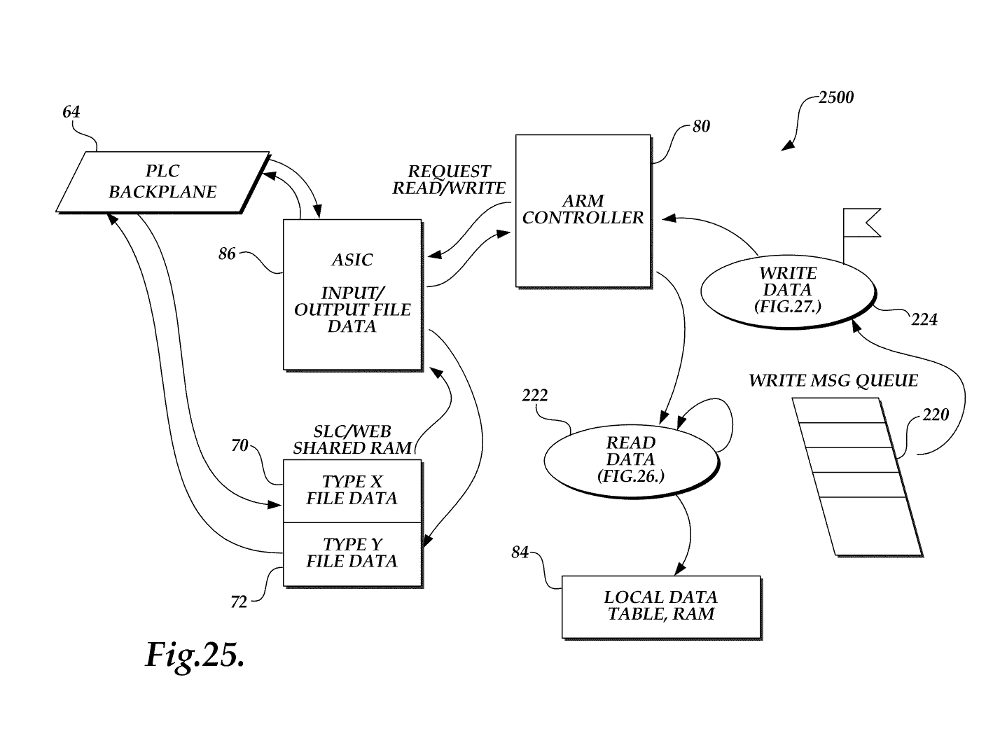

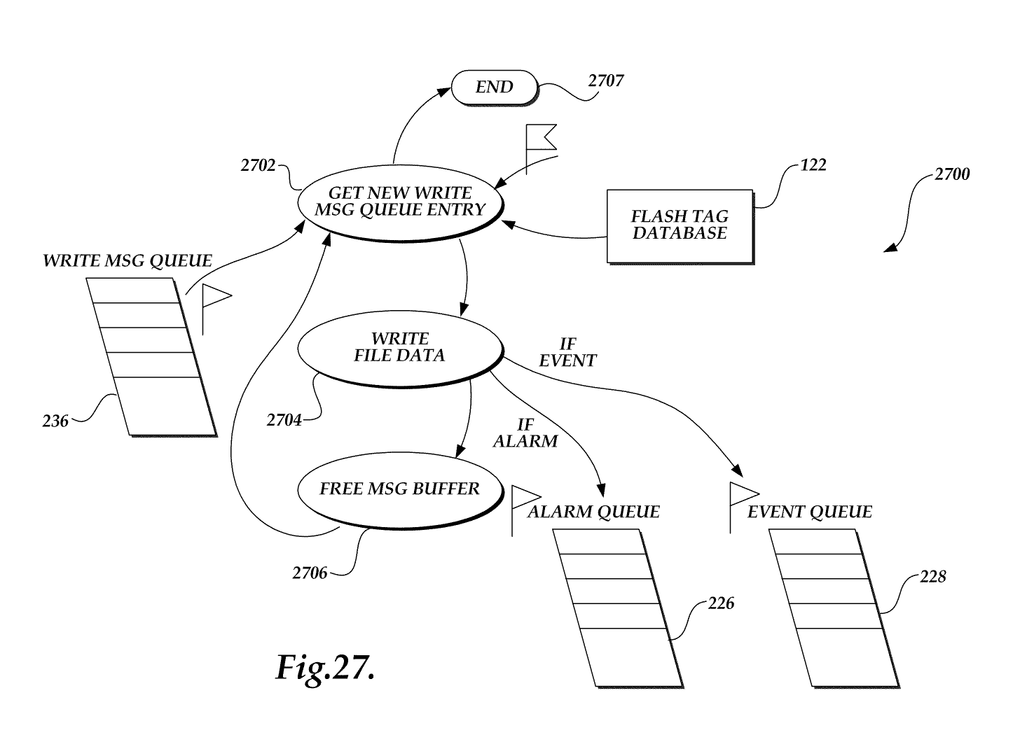

FIG. 25, a PLC backplane hardware/software interface will be described. As shown in FIG. 25, the write message queue 220 is utilized by a write data task 224 to periodically write data to the SLC backplane 64 in response to the occurrence of a queued message. Data to be written is transferred to the ARM controller 80 and, subsequently, to the backplane ASIC 86. The backplane ASIC 86 utilize the shared RAM 70 to store type X data and type Y data containing the information to be made accessible from the backplane. The data to be written then be transferred from the type Y data file 72 to the SLC backplane 64 where it is written. An illustrative state machine for providing a write data task will be described below with reference to FIG. 27.

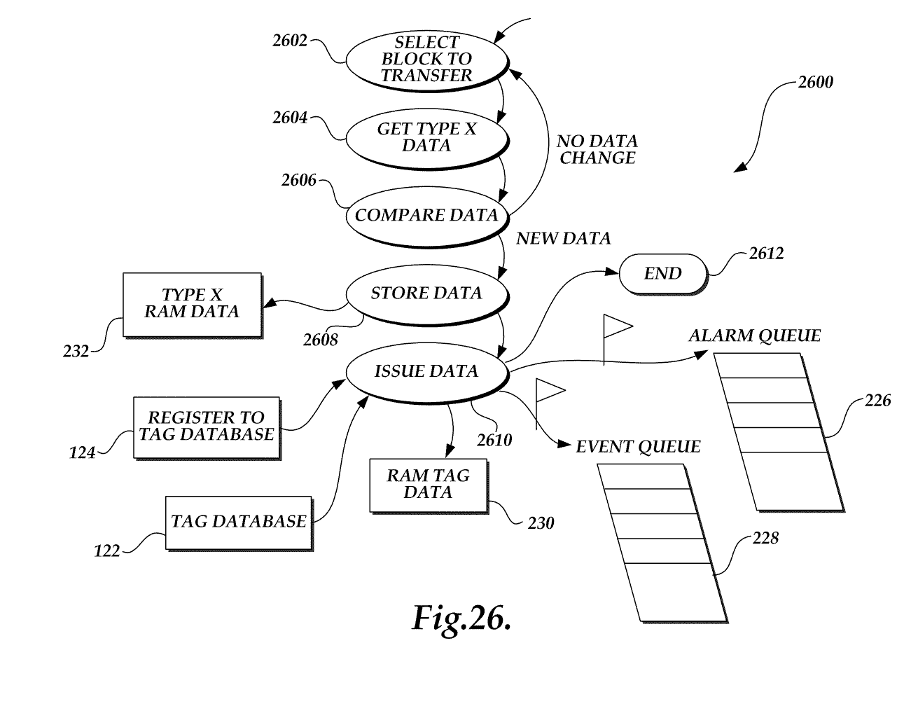

Similarly, a read data task 222 continuously executes to pull data from the type X data file 70 stored in the shared RAM and to store the data in the local read data table 84 for quick access. In order to pull data from the shared RAM in this manner, the read data task 222 communicates with the ARM controller 80 and the backplane ASIC 86. An illustrative state machine for providing a read data task will be described below with reference to FIG. 26.

Referring now to FIG. 26, an illustrative state machine 2600 will be described illustrating the operation of a read data task. The state machine 2600 begins at state 2602, where the block of data to be transferred is selected. The state machine 2600 then continues to state 2604, where the type X data is retrieved. At state 2606, the retrieved data is compared to data currently stored in the type X data file. If there has been no change in the data, the state machine 2600 transitions back to state 2602 where another block of data is retrieved. If the data has been modified, the state machine 2600 transitions to state 2608, where the type X data is stored in RAM 232. The state machine 2600 then transitions to state 2610, where the new data is issued to the appropriate memory location or queue. The state machine updates the tag data stored in RAM 230 with the new data. To accomplish this, the register to tag database 124 and the tag database 122 be consulted. If event and/or alarm conditions for the particular tag are met, the new data is issued to the event queue 228 and the alarm queue 226. The state machine 2600 then transitions from state 2610 to state 2612.

Referring now to FIG. 27, an illustrative state machine 2700 will be described for performing a write data task. The purpose of the write data task is to extract messages from the ASIC message queue and issue the data to the PLC 24 appropriately. Because alarms or events be based on the Web server module 22 to PLC 24 writing direction, the write data task shown in FIG. 27 also watches for alarm or event conditions and adds entries to the alarm queue 226 or the event queue 228 appropriately.

The state machine 2700 begins at state 2702, where a new write message queue entry is retrieved from the write message queue 236 and evaluated. Using the tag database 122, the state machine 2700 then transitions to state 2704, where the file data is written to the appropriate location, either the backplane ASIC 86 or the shared RAM space 70 or 72. If the tag database 122 indicates alarm or event conditions have been met, entries are made into those queues, respectively. From state 2704, the state machine 2700 transitions to state 2706, where the message buffer is cleared. The state machine 2700 then transitions back to state 2702 where the write message queue is examined for more messages to evaluate. If the queue is empty, the state machine 2700 transitions to state 2707 and ends.

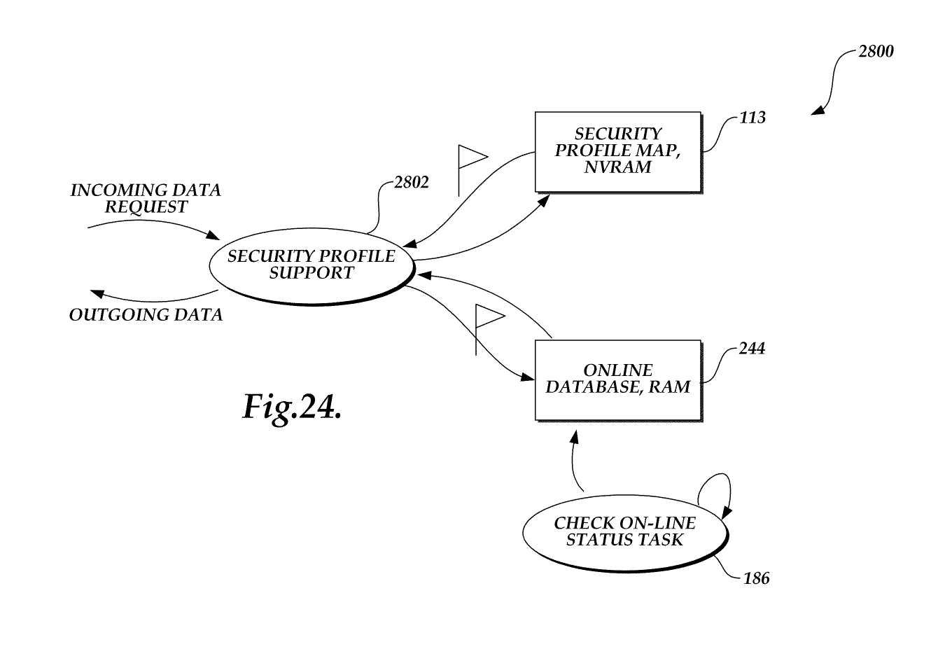

Turning now to FIG. 24, an illustrative state machine 2800 will be described illustrating security profile support. The security profile support accesses the online database in RAM 244 that is maintained by the check online status task 186, along with the security profile map 113 stored in non-volatile RAM, which has been defined and downloaded by the user. The security profile map 113 identifies, for each user, the security level and privileges for that user. The security level be set separately for each screen contained in the Web site supplied by the Web server module 22. Accordingly, the state machine 2800 begins at state 2802, where the security profile support mechanism is queried through an incoming data request. The appropriate data is retrieved from the online database 244 and the security profile map 113 to respond to the request. The request is responded to by providing outgoing data describing whether a user is currently online and whether the user has appropriate access for the requested screen. In this manner, the state machine 2800 can provide security clearance for each user and each requested screen of the Web site provided by the Web server module 22.

Turning to FIG. 28, aspects of the Web server module configuration application 48 will be described. As mentioned briefly above, the Web server module configuration application 48 executes on the remote computer 26 and provides a flexible, easy-to-use interface for creating the Web site supplied by the Web server module 22. In particular, the Web server module configuration application 48 receives input from a user and, in response, creates the databases necessary for the Web server module 22 to dynamically generate the Web site. The Web server module configuration application 48 also allows a user to provide information necessary to configure each aspect of the Web server module 22, including the ethernet port, the serial port, and other hardware features of the Web server module 22.

FIG. 28 shows an illustrative screen diagram representing one screen of the Web server module configuration application 48 for configuring the Web server module 22. As shown in FIG. 28, this screen allows a user to configure the Web server module 22 by providing a module reference 254, a rack designator 256, a slot designator 258, and a host name 260. Information regarding the Internet protocol address 248, the subnet mask 250, and the gateway address 252 for the Web server module 22 also be provided. Additionally, information regarding an e-mail server port 262 and the server port IP address also be provided. This information is downloaded to the Web server module 22 from the remote computer 26 and is utilized to configure the hardware of the Web server module 22. Similar information also be provided by a user in another screen for configuring the serial port 32 of the Web server module 22.

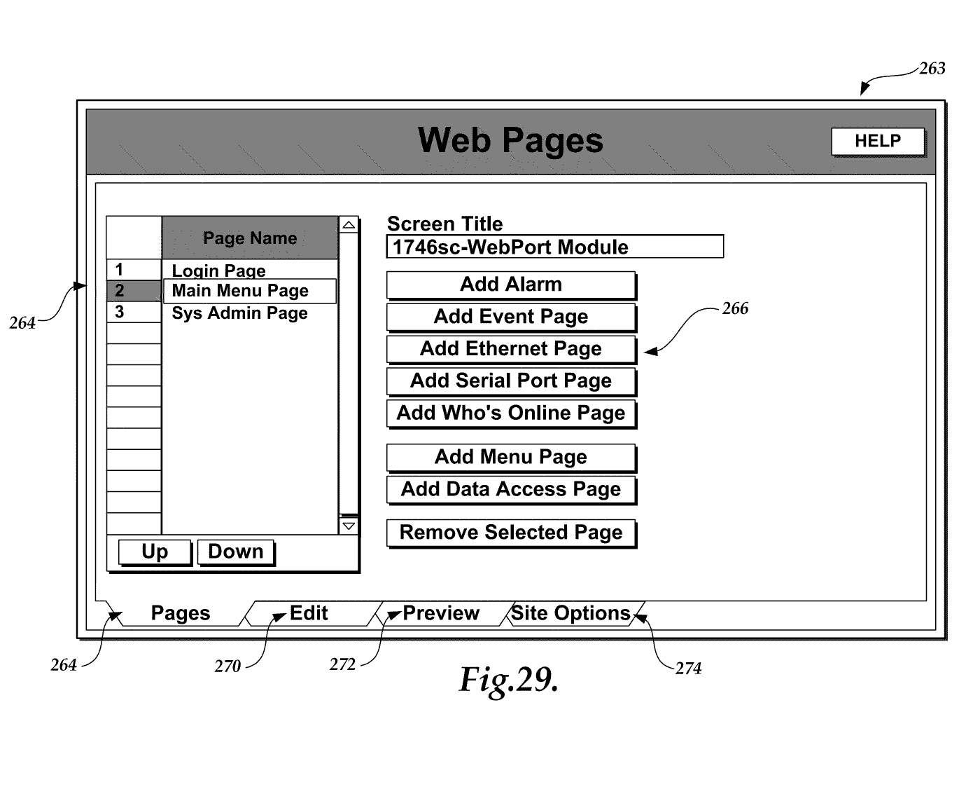

Referring now to FIG. 29, another illustrative screen diagram illustrating an aspect of the Web server module configuration application 48 will be described. As shown in FIG. 29, a screen is provided that easily allows a user to add pages, subtract pages, or modify pages of the Web site provided by the Web server module 22. In particular, a page list grid control 264 shows a list of all currently defined pages. Each page is defined by a page name which is user editable. A menu 266 is also provided showing a list of available page types that be added to the Web site. In response to the selection of one of the menu items contained in the menu list 266, a new Web page is added to the page list grid control 264. This new page becomes a part of the Web site and be edited by the user. Additional tabs 270, 272, and 274 are provided for editing any of the pages listed in the page list grid control 264, previewing a page, or for specifying other site options, respectively. Through the use of the screen shown in FIG. 29, a user easily build a Web site to be provided by the Web server module 22 without programming or writing in markup language.

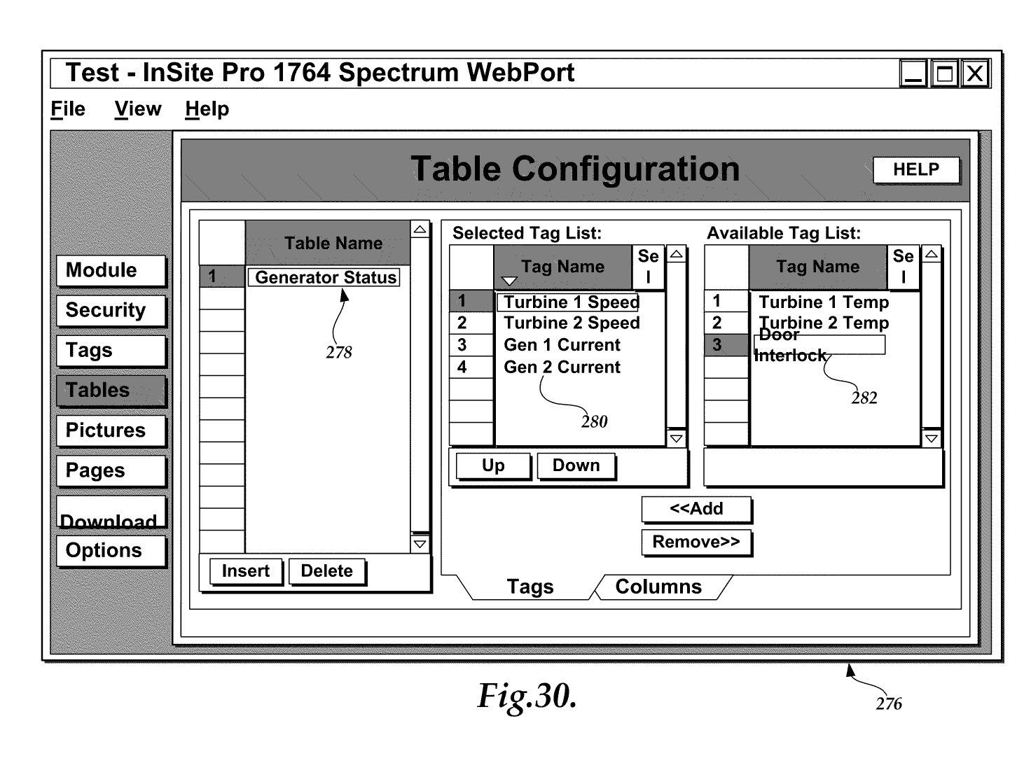

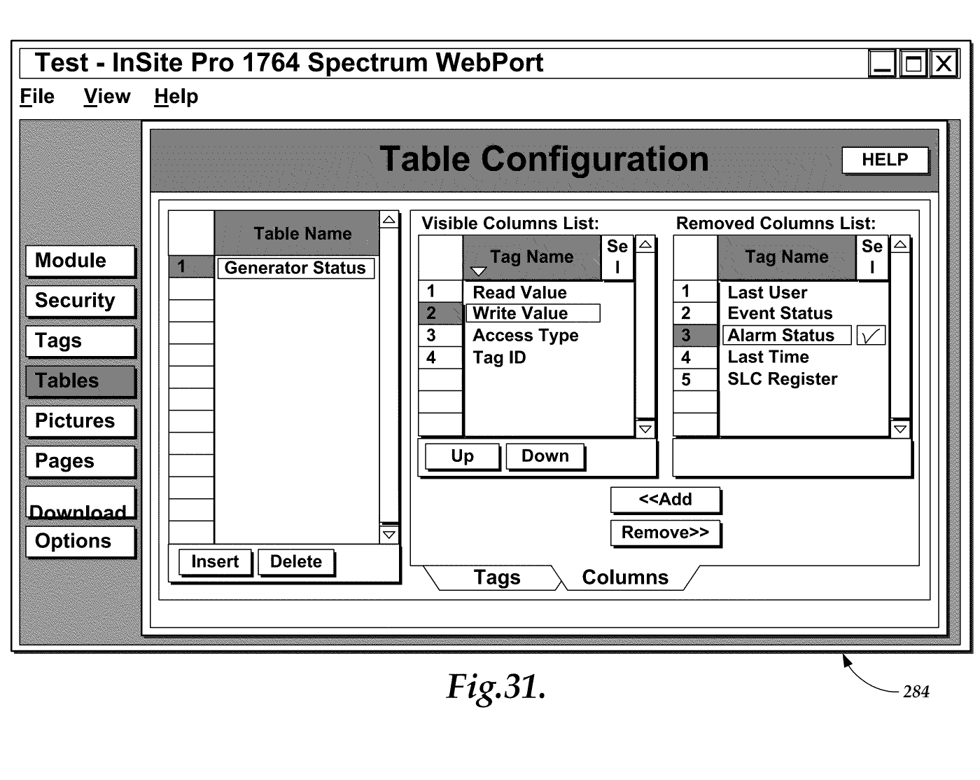

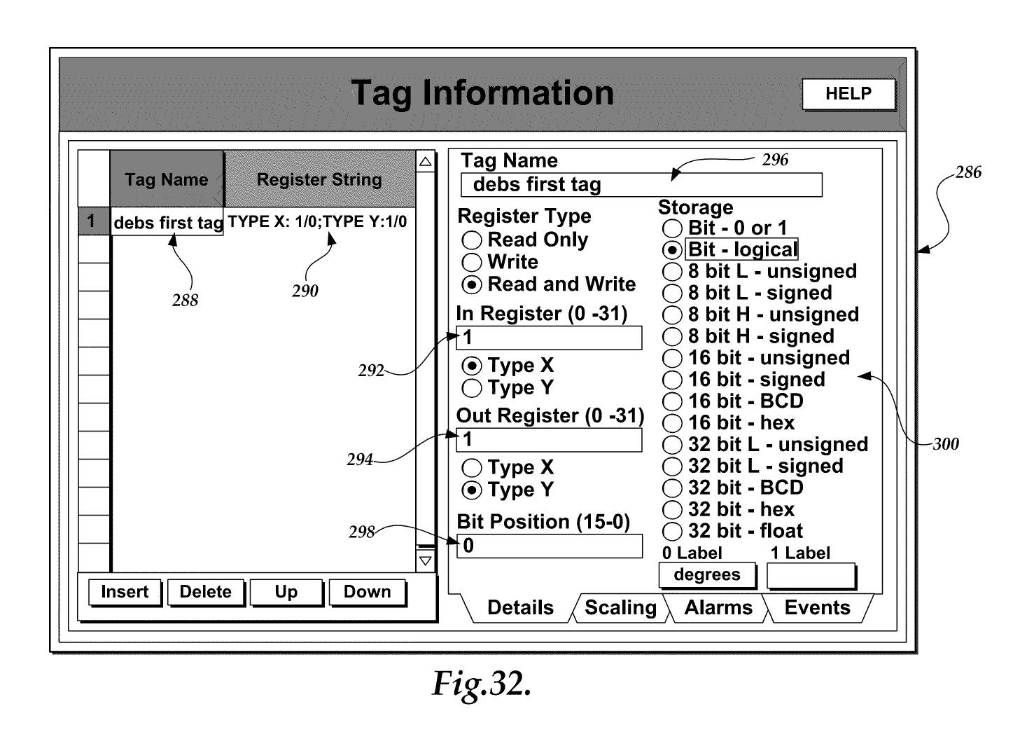

Referring now to FIGS. 30 and 31, additional screens of the Web server module configuration application 48 will be described. As shown in FIGS. 30 and 32, these screens allow a user to create tables and to specify the tagged data items and columns that appear in the tables. The table list 278 shows the names of all currently defined tables. A user select one of the tables shown in the table list 278 for editing and use either of the tabbed views shown in the bottom portion of the screen 276 to edit the table. In particular, the “tags” tab shown in FIG. 30 be utilized to select which tag data will appear in the table, and the order in which the data will appear. Tagged data items are selected by the user from a list of tags previously defined by the user. An illustrative screen diagram will be described below with reference to FIG. 32 for creating and editing tags. As shown in FIG. 31, the “columns” tab be utilized to allow users to select the columns that appear in the table and their order. Users also select from a list of available columns in the screen diagram shown in FIG. 31.

Referring now to FIG. 32, another screen of the Web server module configuration application 48 will be described. As shown in FIG. 32, a tag definition screen 286 be provided that allows a user to completely define the tag names and associated register assignment details. For each tag, a user provides the following information: tag specifications in a details tab; scaling usage in a scaling tab; alarm specifications in the alarm tab; and event specifications in the event tab. The details tab is shown in FIG. 32. The fields shown in the details tab be utilized to identify a tag name 296, a register type, and to specify the particular input or output registers 292 and 294, respectively. The bit position 298 and type of storage 300 also be specified by the user. Based on the user's input, a register string 290 is generated that describes the tag.

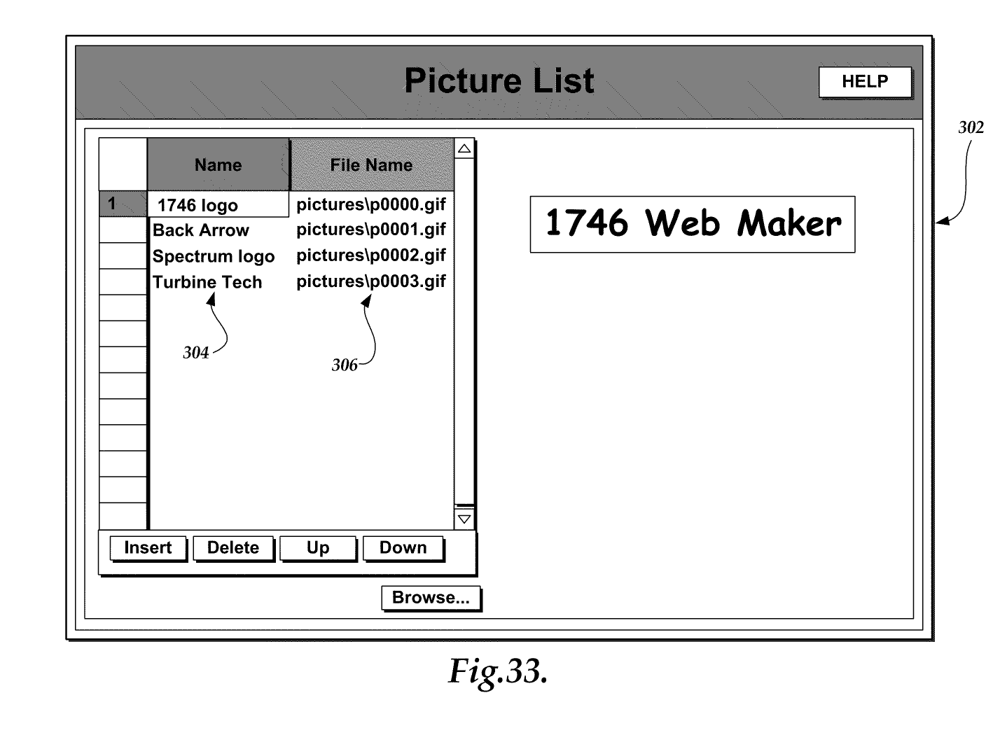

Referring now to FIG. 33, additional aspects of the Web server module configuration application 48 will be described. As shown in FIG. 33, a picture definition screen is provided that allows a user to import graphical items to be stored in the graphics database 126. The screen shown in FIG. 33 allows users to do this by adding picture file names to a picture list 306 and associating with each file a picture name 304 for easier reference from other screens of the Web server module configuration application 48. As described above, these graphics are transmitted to the Web server module 22 as a part of the graphics database 126.

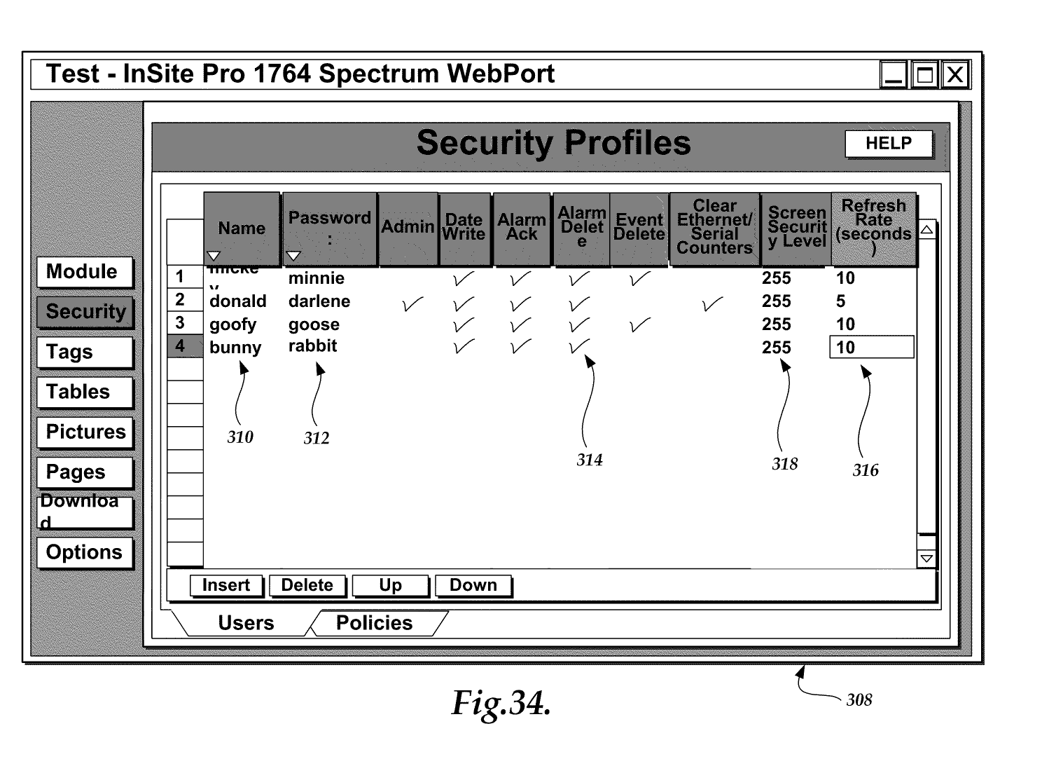

Referring now to FIG. 34, another screen diagram illustrating a screen 308 of the Web server module configuration application 48 will be described.

The screen 308 shown in FIG. 34 is a screen utilized for configuring security profiles. As shown in FIG. 34, a user create new entries in the security profile screen and assign security rights to each of these entries. For instance, a user provide a name 310 for a user, and a user password 312. For each user, the security rights be set by identifying whether the user has permission for administration of the Web server module 22, to write data, to acknowledge alarms, to delete alarms, to delete events, to clear Ethernet communication counters, or to clear the serial port communication counters. A screen security level 318 also be identified that describes the highest level screen to which a user is authorized to view. A refresh rate 316 also be provided that sets the rate at which the user's browser will request information from the Web server module 22. Using the “policies” tab shown in FIG. 34, a user also set the maximum number of sessions that the Web server module 22 supports, and an email address to which email will be transmitted based on the occurrence of an alarm or an event.

From the foregoing, it should be appreciated that the present invention provides a Web server module 22 that can interface with a PLC 24 to provide a Web site, including data regarding the operation of the PLC 24. The present invention also provides a Web server module configuration application 48 that allows a user to completely define the operational characteristics of the Web server module 22 and the Web site to be provided. The Web server configuration application 48 does not require the user to understand markup language or programming. Rather, the user utilize the Web server module configuration application 48 to configure the Web server module 22 by simply selecting and modifying a number of predefined Web pages. Additional pages and associated page linkages can be added at the user's discretion. The user then configure these Web pages in a simple and intuitive manner for their own particular application.

While an illustrative embodiment of the invention has been illustrated and described, it will be appreciated that various changes can be made therein without departing from the spirit and scope of the invention.

The embodiments of the invention in which an exclusive property or privilege is claimed are defined as follows:

1. A system for providing information regarding the operation of a control system, comprising:
a Web server module associated with said control system, said Web server module having a memory operative to store a non-markup language Web site database that be used to dynamically generate a markup language Web page in response to a request, wherein said Web site page is populated by the Web server module with information obtained directly from memory registers of the control system in response to the request;
a remote computer operative to receive user-defined non-markup language configuration data defining attributes of said Web site, to store said configuration data as said non-markup language Web site database, to transmit said non-markup language Web site database to said Web server module, and to request and receive said markup language Web page from said Web server module;
a Web server module configuration application associated with the remote computer operative to create said non-markup language Web site database from information obtained locally at the remote computer and to transmit said database to said Web server module in response to the request; and
wherein the Web server module is further configured to receive the non-markup language database from the remote computer in a request and to dynamically generate a markup language Web page that includes information obtained directly from memory registers of the control system in response to said request.

2. The system of claim 1, wherein said Web server module is further operative to identify a user associated with said request and to determine if said user is authorized to receive said Web page based on received privilege information.

3. The system of claim 1, wherein said Web server module is operative to transmit said dynamically generated markup language Web page to the remote computer making said request.

4. The system of claim 3, wherein said non-markup language Web site database further comprises a security profile map defining security level and privilege information for one or more users, and wherein said Web server module is further operative to identify a user associated with said request and to determine if said user is authorized to receive said Web page based upon an entry in said security profile map associated with said user.

5. The system of claim 1, wherein said non-markup language Web site database further comprises data defining a Web page comprising a table for reading or writing the contents of a memory register contained within said control system.

6. The system of claim 1, wherein said non-markup language Web site database further comprises data defining a Web page comprising a non-text rendering of read or write data corresponding to contents of a memory register contained within said control system.

7. The system of claim 5, wherein said request comprises a request for said Web page comprising a table, and wherein said Web server module is operative to identify said memory register, to determine the contents of said memory register, and to create said Web page comprising a table containing said contents of said memory register.

8. The system of claim 6, wherein said request comprises a request for said Web page comprising a non-text rendering, and wherein said Web server module is operative to identify said memory register, to determine the contents of said memory register, and to create said Web page comprising a non-text rendering based upon said contents of said memory register.

9. The system of claim 3, wherein said Web server module is electrically connected to said control system controller through a backplane interface.

10. The system of claim 3, wherein said Web server module is electrically connected to said control system controller through a serial interface.

11. The system of claim 3, wherein said Web server module is electrically connected to said control system controller through a network interface.

12. The system of claim 3, wherein said request comprises a hyper-text transport protocol request and wherein said request is received from a Web browser executing on said remote computer.

13. The system of claim 1, wherein said dynamically generated markup language Web page comprises a Web page identifying an alarm generated by said Web server module through the monitoring of data for said control system.

14. The system of claim 1, wherein said dynamically generated markup language Web page comprises a Web page identifying an event generated by said Web server module through the monitoring of data for said control system.

15. The system of claim 1, wherein said Web server module further comprises an Ethernet interface for receiving said non-markup language Web site database and said requests and wherein said dynamically generated markup language Web page comprise a Web page providing information regarding the status of said Ethernet interface.

16. The system of claim 1, wherein said Web server module further comprises a serial port interface and wherein said dynamically generated markup language Web page comprise a Web page providing information regarding said serial port interface.

17. The system of claim 1, wherein said dynamically generated markup language Web page comprises a Web page providing system administrator or specific user-allowed access that allows active browser session modification of said security profile privileges.

18. The system of claim 1, wherein said Web server module is further operative to receive a plurality of said requests and wherein said dynamically generated markup language Web page comprise a Web page identifying a like plurality of users connected to said Web server module and associated with said plurality of requests.

19. A method for providing information regarding the operation of a control system, comprising:
receiving user-defined non-markup language configuration data defining attributes of a Web site wherein the Web site corresponds to aspects of a programmable logic controller defined by a user wherein said configuration data defines a table with entries corresponding to the contents of read or write memory registers contained within said control system, wherein said data defining said table is created by receiving a mapping of a text tag to said memory register and by receiving a selection of said tag and a request that said tag be displayed in said table;
storing said configuration data as a non-markup language Web site database; and
in response to a request, dynamically generating a Web page defined by the non-markup language configuration data stored as a non-markup language Web site database that provides information regarding the operation of a control system.

20. The method of claim 19, further comprising transmitting said non-markup language Web site database to a Web server module associated with said control system, wherein said Web server module is operative to receive requests for said Web site and to generate markup language Web pages from said non-markup language Web site database in response to said requests.

21. The method of claim 19, wherein said data defining said non-text rendering is created by receiving a mapping of a tag to said memory register and a request that said tag be displayed via said non-text rendering.

22. The method of claim 19, wherein said configuration data comprises an internet protocol address for said Web server module.

23. The method of claim 19, wherein receiving non-markup language configuration data defining a Web site comprises receiving the selection of one or more of a plurality of defined Web pages.

24. The method of claim 19, wherein said plurality of defined Web pages comprises a security page, an alarm Web page, an event Web page, an Ethernet Web page, a serial port Web page, a menu Web page, a data access Web page, a page identifying online users, or a systems administrator page.
